(19) United States
(12) Patent Application Publication
(10) Pub. No.: US 2016/0007182 A1
(43) Pub. Date: Jan. 7, 2016

(54) Directing Information Based on Device Proximity

(71) Applicant: Remember Everyone, LLC, Prairie Village, KS (US)

(72) Inventor: Samuel Benjamin Raiche, Plymouth, MN (US)

(21) Appl. No.: 14/322,225

(22) Filed: Jul. 2, 2014

(51) Int. Cl. H04W 8/00; H04W 68/00; H04W 76/02; H04W 4/02

(52) U.S. Cl. CPC H04W 8/005; H04W 4/023; H04W 68/005; H04W 76/021; H04W 4/06

(57) ABSTRACT

A method includes detecting on a computing device that a second computing device is within wireless range of the computing device and transmitting an instruction from the computing device to a server to send contact information for interactive communications to the second computing device.

### BACKGROUND

Computing devices such as desktop computers, laptop computers, tablets, and cellular phones provide a wide array of communication channels for communicating with users including voice calls, video calls, texting, email, and Internet-based communications such as webpages and social media postings.

In general, there are two ways to communicate with users over a communication channel. The first is to generically address the information to multiple users, by for example placing the information on a webpage that is accessible by any user or publishing the information on a social media posting that can be read by any user. Alternatively, information can be communicated in a direct fashion if contact information for the user is available. For example, if the email address of the user is known, information can be sent to the user through email. In addition, if two devices are able to make a direct connection with each other, it is possible for information to be conveyed between the two devices.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes detecting on a computing device that a second computing device is within wireless range of the computing device and transmitting an instruction from the computing device to a server to send contact information for interactive communications to the second computing device.

A second method includes detecting a wireless signal from a mobile device and determining an identifier for the mobile device from the wireless signal. The identifier is transmitted to a server to trigger the server to send information to the mobile device such that the server uses a different identifier for the mobile device in order to route the information to the mobile device.

A third method includes displaying a user interface on a device showing images of people in proximity to the device and through the user interface, providing the ability to share contact information with the people displayed on the user interface before receiving contact information from the people displayed on the user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 provides a flow diagram for proximity-based information sharing.

FIG. 2 provides a plan view of a system used in FIG. 1.

FIG. 3 provides a block diagram of elements shown in FIG. 2.

FIG. 4 provides a more detailed block diagram of the memory of the server of FIG. 3.

FIG. 5 provides a flow diagram for registration and login.

FIG. 6 provides an example user interface of an initial screen.

FIG. 7 provides an example user interface for registering.

FIG. 8 provides an example user interface for signing in using an email account.

FIG. 9 provides a flow diagram for identifying nearby users and sharing information with nearby users.

FIG. 10 provides an example home page user interface showing nearby users and recent contacts.

FIG. 11 provides a flow diagram for sending information to another device using the user interface of FIG. 10.

FIG. 12 provides a user interface depicted after an information card is selected.

FIG. 13 provides a user interface showing the information card being dragged to a nearby user photo.

FIG. 14 shows a confirmation screen to confirm that information should be sent to a nearby user.

FIG. 15 provides a user interface that is displayed when a user is notified that someone wishes to share information with them.

FIG. 16 provides a flow diagram for interacting with the notification of FIG. 15.

FIG. 17 provides an example user interface after a user has selected the connect button in FIG. 15.

FIG. 18 provides an example user interface after a user has selected the connect button in FIG. 16.

FIG. 19 provides an example home page user interface after information has been accepted.

FIG. 20 provides a flow diagram for interacting with a recently met contacts area of a home page.

FIG. 21 provides a user interface showing a profile page.

FIG. 22 provides a user interface of a search page.

FIG. 23 provides a user interface showing a “where” map.

FIG. 24 shows a user interface when a contact icon is selected on the “where” map.

FIG. 25 provides a user interface showing recent “where” searches.

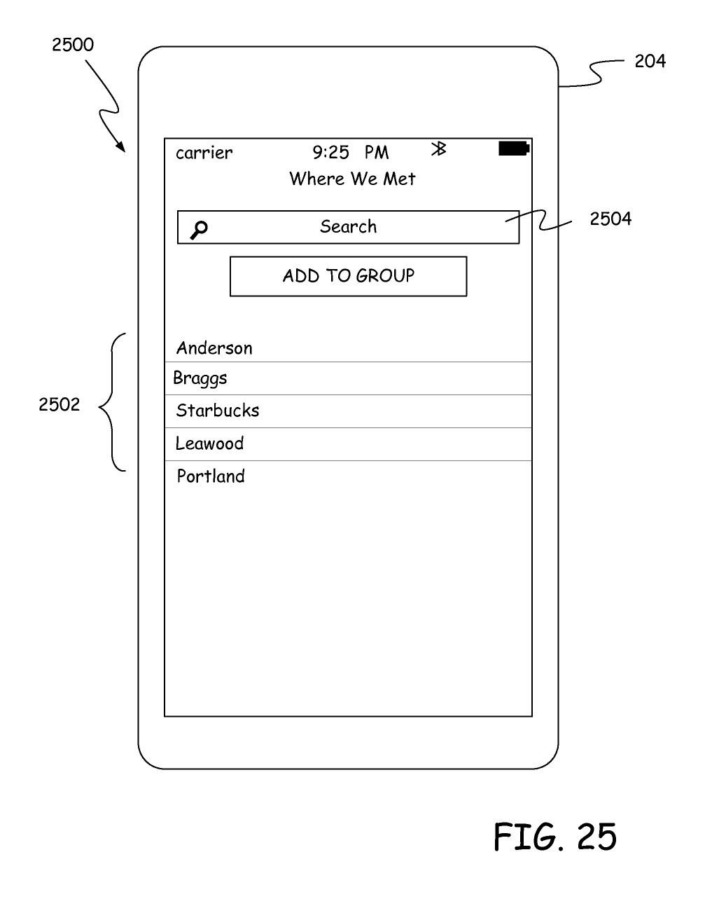

FIG. 26 provides a user interface showing a list of contacts found during a “where” search.

FIG. 27 provides a user interface allowing filter settings for a map to be changed.

FIG. 28 provides a user interface of a month view for a “when” search.

FIG. 29 provides a user interface of a year view of a “when” search.

FIG. 30 provides a list view for a “when” search.

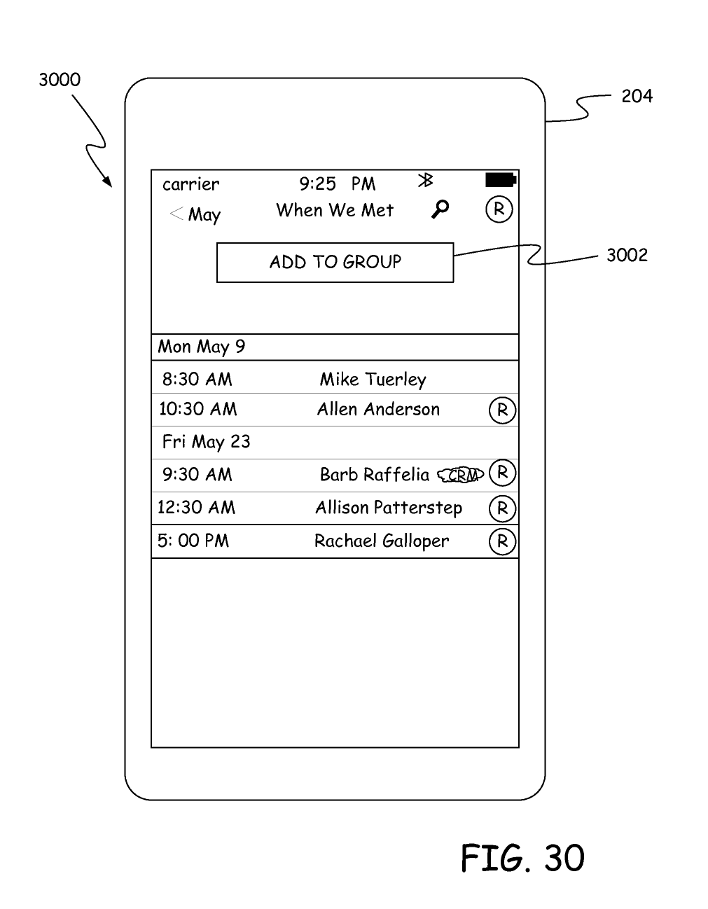

FIG. 31 provides a user interface of an initial text search page.

FIG. 32 provides an example of a user interface when a user taps in the search text box of FIG. 31.

FIG. 33 provides a user interface for a group search.

FIG. 34 provides an example of a user interface when a group is selected.

FIG. 35 provides a flow diagram for adding members to a group.

FIG. 36 provides a flow diagram for event location auto grouping.

FIG. 37 provides a flow diagram for suggesting information sharing based on a history of proximity.

### DETAILED DESCRIPTION

In the embodiments described below, systems and methods are provided to direct information to a particular person based on a physical proximity with that person without having to know the person's location or contact information and without having to establish a device-to-device connection between that person's device and a device in proximity with that person. Thus, the information being shared does not have to be broadcast to a large number of people, but instead can be directed only to those people that are proximate or near a particular user. In addition, the person receiving the information does not have to share their contact information or their location information with a stranger and does not have to agree to a connection between their device and a stranger's device before receiving information. Specifically, a user is able to receive information associated with a nearby entity without having to share location information, an email address, phone number or social media identifiers with an unknown entity.

In addition, embodiments described below limit the information that is sent to a user by requiring an entity wanting to send information to be in proximity with the user. This greatly reduces the amount of information that is sent to the user and also increases the likelihood that the information will be relevant to the user.

Embodiments described below also provide searching abilities that allow users to search not only where and when they received information from an entity, but also location information for the entity stored in one or more social media sites.

In further embodiments, a server is able to maintain a database indicating how often two entities have been in proximity with each other such that the server can recommend to one or both of the entities that they exchange contact information and so that the server can provide such proximity information to law enforcement.

In further embodiments, a server is able to determine when a user's device is within a broadcast range of a broadcasting device and is further able to automatically group contacts based on the fact that the user's device detected the broadcasting device.

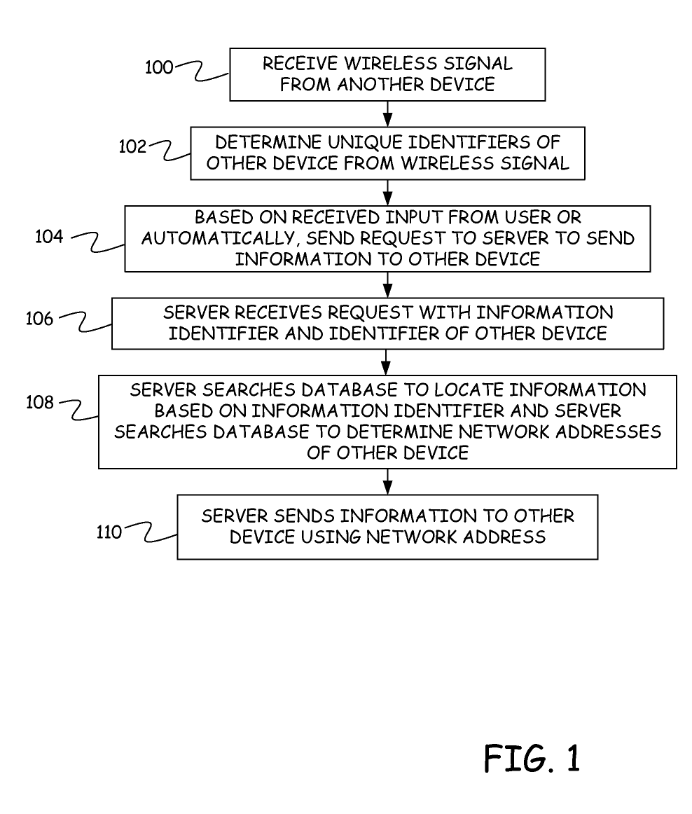

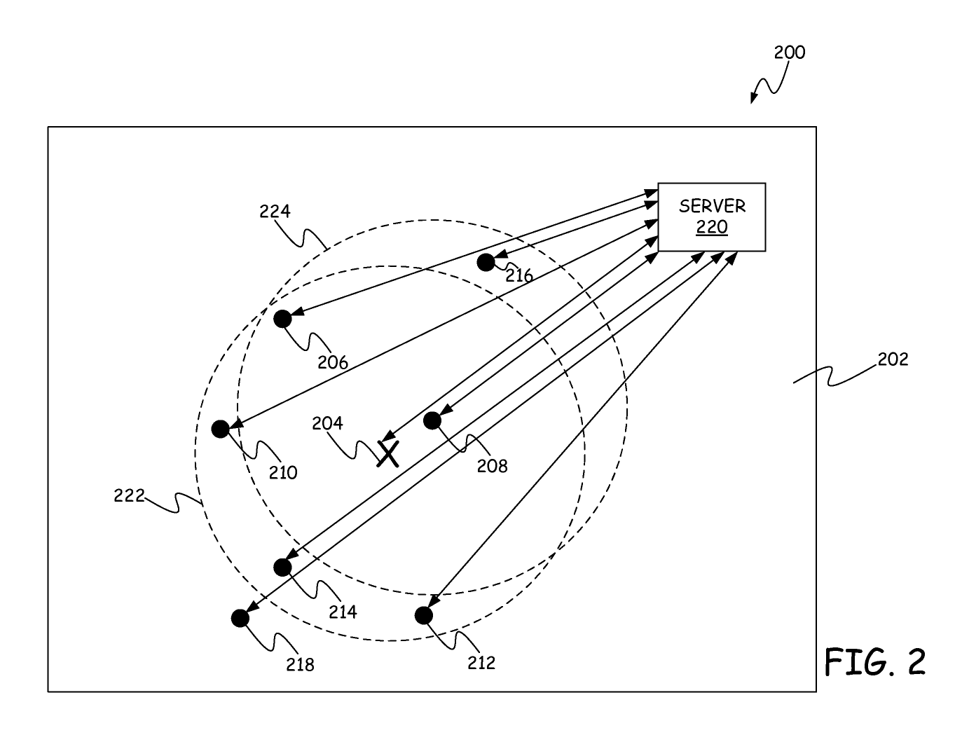

FIG. 1 provides a flow diagram of a method of transmitting information based on proximity and FIG. 2 provides a plan view of a system 200 for implementing the method of FIG. 1. As shown in FIG. 2, in an area 202, electronic devices, such as devices 204, 206, 208, 210, 212, 214, 216 and 218 are positioned relative to each other. Electronic devices 204, 206, 208, 210, 212, 214, 216, and 218 can be any electronic device including a stationary device such as a desktop computing device, or a mobile device such as a laptop computer, personal digital assistant, tablet computer, and smart phone, for example. Area 202 may be an area within an airport, restaurant, bar, or convention center, for example. Each of the devices is in communication with a server 220 through a wired or wireless connection to a network (not shown). Each of the devices includes a transceiver that is capable of transmitting a wireless signal and receiving such wireless signals. For example, each device may be equipped with a Bluetooth transceiver that is able to communicate using the Bluetooth protocol. As is known by those skilled in the art, such wireless transceivers have a limited range, which in the case of Bluetooth is generally less than 100 yards. In FIG. 2, circle 222 represents the boundary of the reception range of device 204 and circle 224 represents the boundary of the reception range of device 208. Thus, a device must be within boundary 222 in order to have its wireless signal received by device 204 and must be within boundary 224 to have its wireless signal received by device 208. For example, device 216 and device 218 are outside of boundary 222 and as a result, device 204 cannot detect the wireless signals generated by devices 216 and 218. Boundaries 222 and 224 assume that each device has the same transmission range. Those skilled in the art will recognize that devices with a smaller transmission range will have to be closer to the receiving device in order to have their wireless signals received and devices with larger transmission ranges can be outside of boundaries 222 and 224 and still have their wireless signals received.

At step 100, an electronic device receives a wireless signal from another electronic device. For the remainder of the application, device 204 of FIG. 2 will be considered the electronic device that received this wireless signal and electronic device 210 will be considered the device that sent this wireless signal. However, any of the electronic devices of FIG. 2 could fulfill either role. In accordance with one embodiment, the received wireless signal is a short-range wireless signal with an expected range of less than 200 yards. Thus, by receiving the wireless signal, device 204 detects that device 210 is within the wireless range of device 204. At step 102, device 204 determines a unique device identifier of device 210 from the wireless signal. For example, if the Bluetooth protocol is used, the unique device identifier is the identifier assigned to the device for Bluetooth communications.

It should be noted that although device 204 receives the wireless signal from device 210 and determines the unique identifier in the wireless signal at steps 100 and 102, device 204 and device 210 do not establish a direct communication connection. In particular, device 204 does not transmit a response signal to device 210 and does not attempt to negotiate a communication channel with device 210.

At step 104, device 204 sends or transmits a request to a server 220 to send information to device 210. This request can be sent in response to input from a user or may be sent automatically based on the detection of the unique identifier. As part of transmitting the request or before transmitting the request, device 204 also transmits the unique identifier of device 210. If the unique identifier is sent before the request to send information, server 220 can provide a different identifier for device 210 that device 204 can supply in the request to send information in place of the unique identifier detected by device 204. The request to send information also includes an information identifier that identifies the information to be sent to device 210. The information identifier can include an identifier of a person or entity registered with server 220 as well as an identifier of information stored for that entity on server 220. The information identifier can identify information such as contact information, product information for ordering a product and promotional information, for example.

At step 106, server 220 receives the request, the information identifier and the unique identifier of device 210. At step 108, server 220 searches its database to locate the information that is to be sent based on the information identifier. Server 220 also searches the database to determine a network address of device 210 based on the unique identifier that server 220 received or if the server provided another identifier for device 210 to device 204, based on the identifier for device 210 provided by server 220 to device 204. The network address of device 210 will be different from the unique identifier and often times will be a TCP/IP address. Thus, server 220 uses a different network address to route the information to device 210 than the unique identifier that it receives. At step 110, server 220 sends the information to device 210 using the network address.

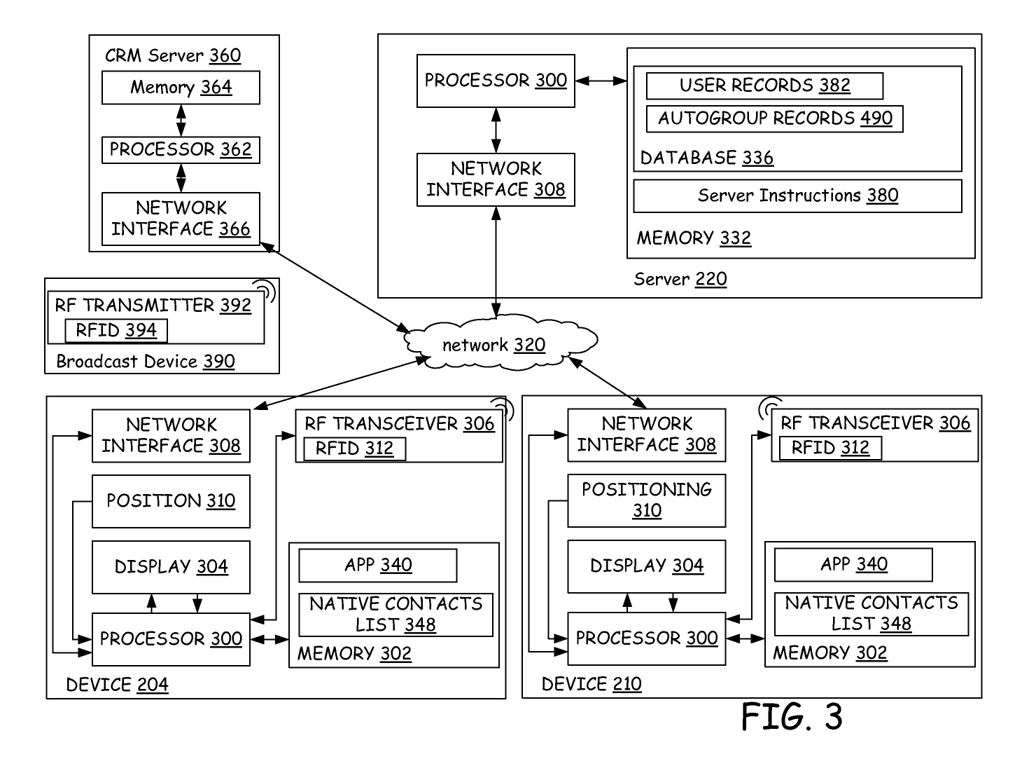

FIG. 3 provides a block diagram of a communication system, which includes server 220 and electronic devices 204 and 210 as well as other devices and a network. In FIG. 3, devices 204 and 210 are shown to have substantially identical components. However, devices 204 and 210 may be different types of electronic devices having different specific implementations of these components and having various different additional components. Devices 204 and 210 include one or more processors 300, one or more memories 302, a display 304, a Radio Frequency (RF) transceiver 306, a position module 310 and a network interface 308. Processor 300 is in communication with each of memory 302, display 304, RF transceiver 306, network interface 308, and position module 310 over one or more signal lines or buses. Processor 300 may be a central processing unit or image processors. Processor 300 executes one or more processor-readable instructions stored in memory 302 to implement the methods described herein. These processor-readable instructions are shown collectively as Application 340, but those skilled in the art will recognize that the instructions can be distributed across several applications, modules, application programming interfaces, services, and methods. Memory 302 can take the form of any processor-readable medium including a disk or solid-state memory, for example. Memory 302 includes an operating system (not shown) that includes instructions for handling basic system services and performing hardware-dependent tasks. In some implementations, the operating system can be a kernel. Memory 302 also includes various instructions representing applications that can be executed by processor(s) 300 including communication instructions (not shown) that allow processor 300 to communicate through network interface 308 to a wireless cellular telephony network and/or a wired or wireless packet switched network. Memory 302 also contains various forms of application data used in the methods described herein.

Display 304 displays various user interfaces and in some embodiments takes the form of a touch-sensitive display that is able to receive inputs from the user when the user touches various parts of the display to thereby indicate selection of one or more controls on the user interface. Processor 300 is able to interpret various touch gestures such as pinching to zoom in, separating fingers to zoom out, and drag and drop to move items on the display.

Position module 310 provides location information for device 204 and can include a global positioning system that is able to determine a longitude and latitude based on received satellite signals or alternatively or additionally, can determine a location based on a location of a cell phone tower that is in communication with device 204.

Radio-frequency (RF) transceiver 306 is able to broadcast a radio-frequency signal including a radio-frequency ID 312 that uniquely identifies device 204. RF transceiver 306 is also able to receive radio-frequency signals and to decode the RFID values in those radio-frequency signals. RF transceiver 306 provides the received RFID values to processor 300. Although transceiver 306 is referred to as a radio-frequency transceiver, any short-range wireless transceiver can be used.

Network interface 308 facilitates communication with other devices through a network 320. Network interface 308 includes hardware and software components for various network protocols including local area network (LAN) protocols, Wi-Fi protocols, Bluetooth protocols, wide area network protocols, Internet protocols and cellular protocols. Thus, through network interface 308, device 204 and 210 are able to communicate with network 320 either over a wired connection or a wireless connection such as a wireless connection based on one or more of a Wi-Fi, Bluetooth or cellular protocol.

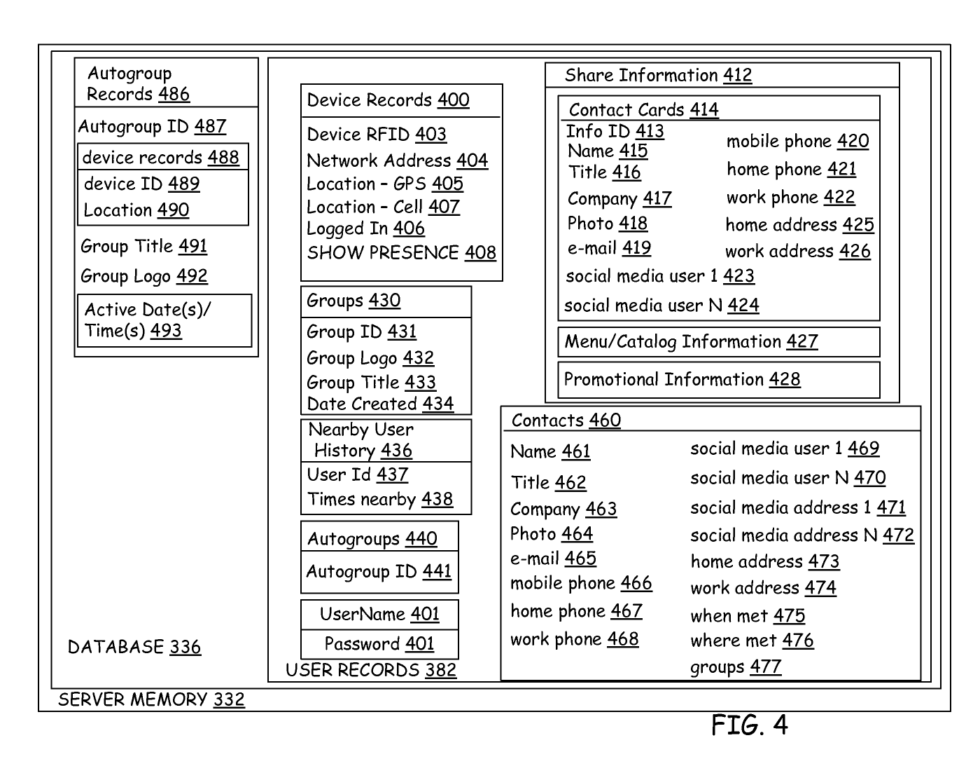

Server 220 includes a processor 330, a memory 332 and a network interface 334. Processor 330 is in communication with network interface 334 and memory 332 over one or more signal lines or buses. Network interface 334 supports all communication protocols necessary for communicating with devices 204 and 210 through network 320 and for communicating with other devices such as CRM server 360. Memory 332 may take the form of any type of processor-readable medium such as disk-based memory or solid-state memory. Memory 332 includes a database 336 for storing application data and one or more collections of server instructions 380 that when executed by processor 330 facilitate one or more of the methods described herein. FIG. 4 provides a more detailed diagram of the contents of database 336, which will be described in more detail with reference to the various methods and user interfaces described below.

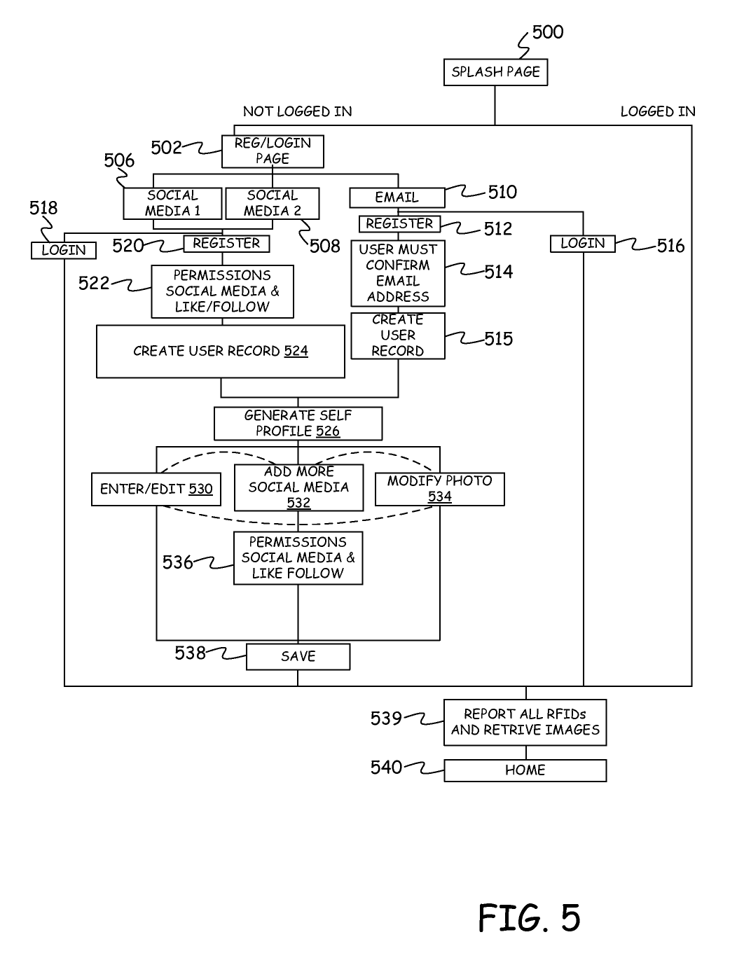

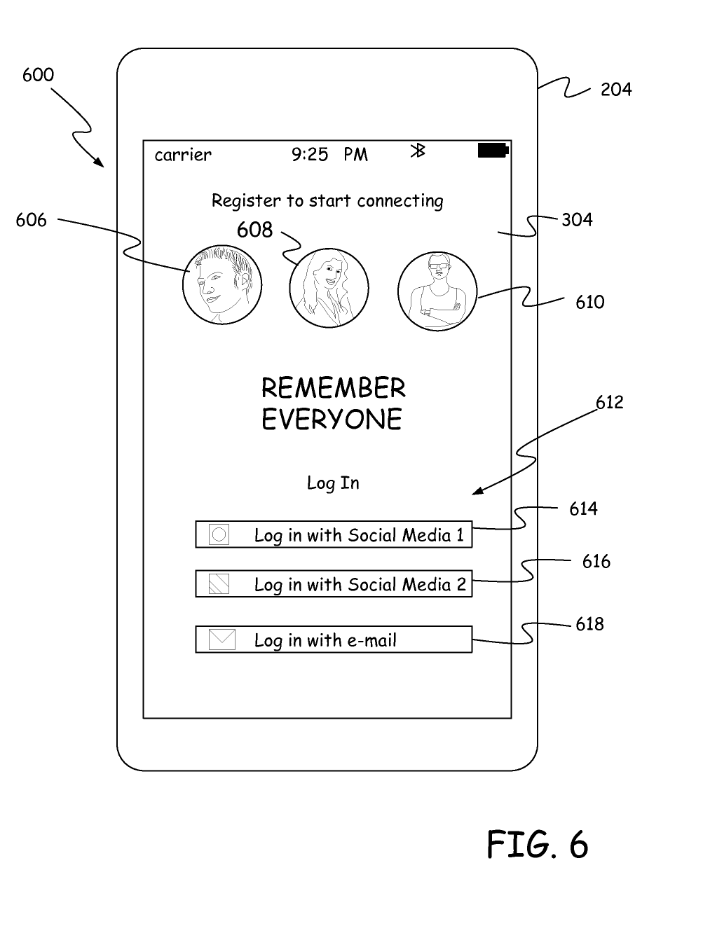

FIG. 5 provides a flow diagram of events that occur after the initiation of application 340 on an electronic device, such as device 204. At step 500, a splash page providing the name of the application is briefly shown to the user. Application 340 then determines if the user is currently logged in to server 220. If the user is not logged in, application 340 loads a registration/login page at step 502, which creates a user interface 600 on display 304 of device 204, as shown in FIG. 6. Before showing user interface 600, application 340 can show one or more tutorials depicting the basic techniques for sharing information and search for previously made contacts and previously accepted information.

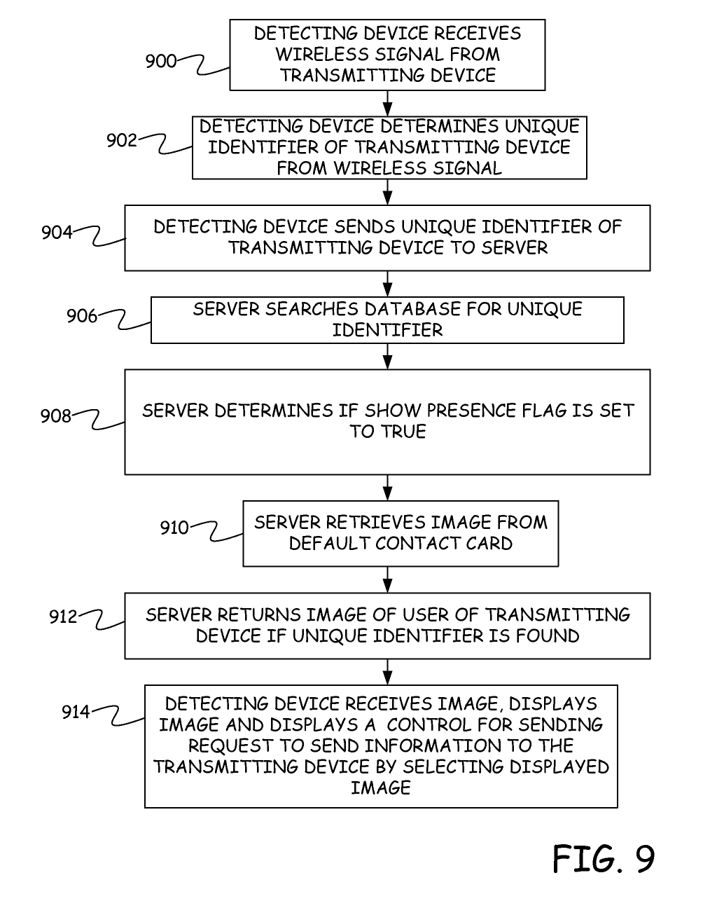

User interface 600 includes images 606, 608 and 610 of users who are in proximity to device 602. The technique for obtaining images 606, 608 and 610 is described further below in connection with FIG. 9. User interface 600 also includes a login/registration area 612, which includes selectable controls 614, 616 and 618. Control 614 allows the user to login through social media 1, control 616 allows the user to login through social media 2 and control 618 allows the user to login with an email address. Social media 1 and social media 2 may be any social media service including such social media services as Facebook, Twitter, LinkedIn, Instagram, and so forth. If the user selects control 614, they are redirected to a login page provided by social media 1 at step 506, where they enter a username and password for social media 1. If the user selects control 616, they are redirected to a social media 2 login page at step 508, where the user enters a username and password for social media 2. Those skilled in the art will recognize that more than two social media login services may be provided on user interface 600.

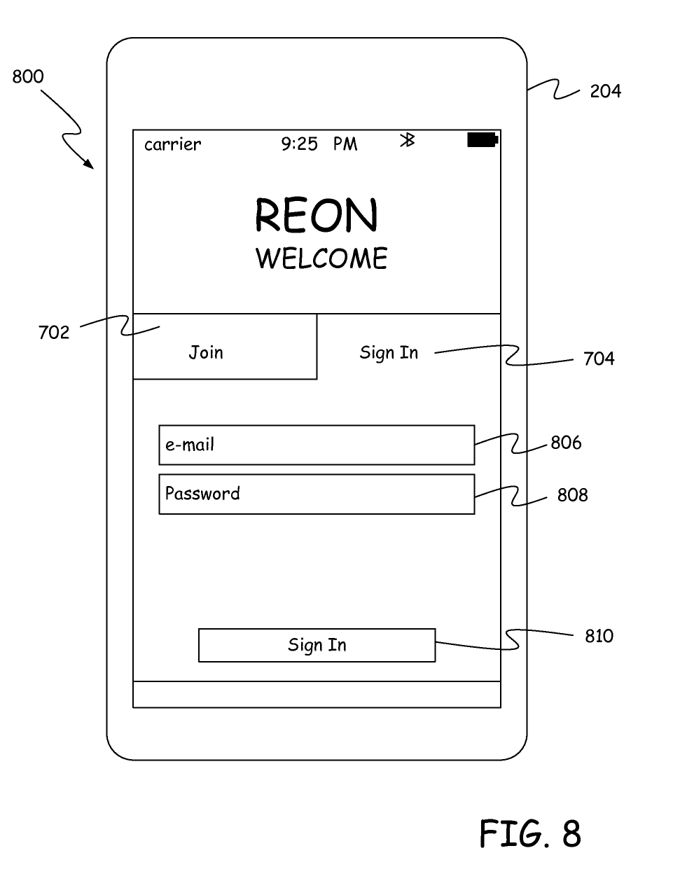

After registration/login redirect steps 506 and 508 of FIG. 8, application 340 must determine if the username used to login into the social media service has previously registered to use application 340. If the username has been previously registered, then the user is logged in at step 518. If the user has not previously registered with that username, the username is registered at step 520. At step 522, application 340 requests permission to access information on the social media user account. In accordance with some embodiments, this involves executing an API exposed by the social media service to request the permission from the user and then using a returned permission token to later access the information on the user's social media account. For example, the permission granted will allow application 340 to access the contents of the user's Facebook page, if the social media service is Facebook and to access the user's LinkedIn information, if the social media service is LinkedIn.

After server 220 has been granted permission to access the information on the social media service at step 522, server 220 creates a new user record 382 for the user in database 336 at step 524. In new user record 382, server 220 fills a username field 401 with the social media username used to log into the social media service and creates a device record 400 and a contact card 414. Device record 400 is created by requesting the radio-frequency identifier of device 204 from device 204 and storing it as device RFID 403. In addition, the network address of device 204 is stored as network address 404, where the network address is provided by device 204 when it establishes communication with server 220. Server 220 also sets a Logged-in toggle value 406 to indicate that the user is currently logged into server 220. Contact card 414 is auto-populated at step 524 by filling in info ID field 413 with a unique identifier for this contact card and filling in name field 415, title field 416, company field 417, email field 419 and one or more of mobile phone field 420, home phone 421 and work phone 422 with corresponding information taken from the social media service, if available. In addition, server 220 stores the social media user name that the user logged in through in one of the social media user fields 423, 424. Additionally, a mail address field 425 or 426 may be auto-populated based on the contents of the social media service. Server 220 will also upload a photo 418 of the user stored on the social media service. Photo 418 may be a single static photo or may be an animated graphics interchange format picture. In other embodiments, photo 418 may be replaced with a video of the user.

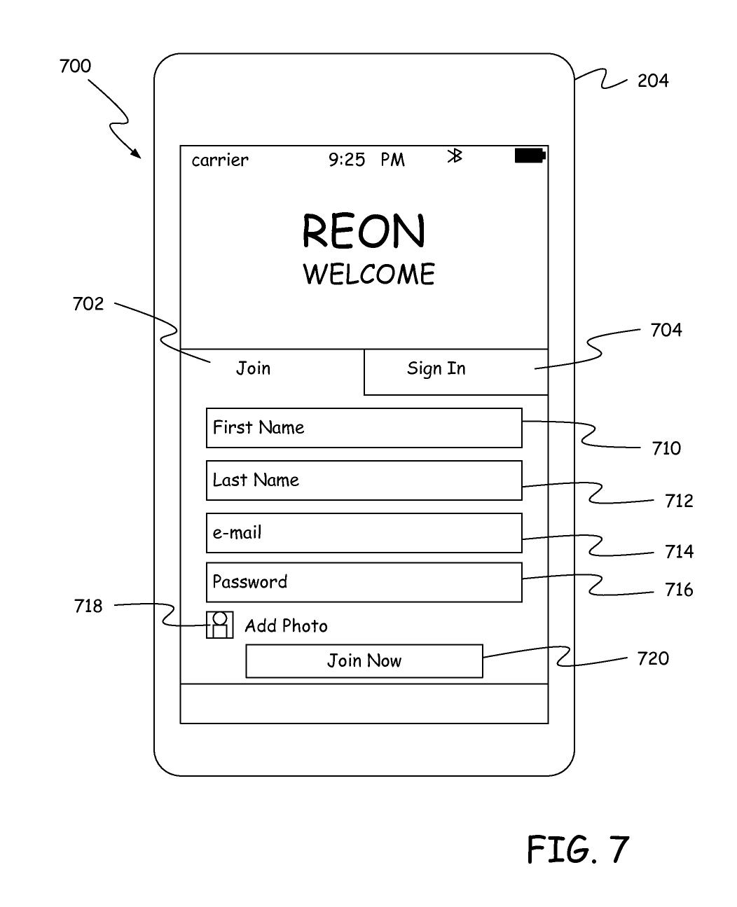

If the user selects to register or login using email control 618 in FIG. 6, an email registration/login page is displayed at step 510. FIG. 7 provides an example of an email registration user interface 700 displayed on display 304 of device 204. Email registration page 700 includes a join or registration tab 702 and a sign-in tab 704. In FIG. 7, join tab 702 is selected and provides text boxes for entering a first name 710, a last name 712, an email address 714 and a password 716. In addition, a control 718 is provided that allows a user to associate a profile photo with their account. After the user has entered information in text boxes 710-716 and has added a photo, they may activate the “Join Now” control 720 to register at step 512. At step 514, the user is asked to confirm their email address.

After the user confirms their email at step 514 of FIG. 5, registration code 380 creates a user record 382 at step 515 by creating a device record 400 and a contact card 414 and by storing the email address as username 401 and an encrypted version of the password as password 402. Device record 400 includes a device RFID 403 that is the RFID 312 of device 204 and the network address 404 of device 204, which is provided when device 204 makes contact with server 220. Server 220 also toggles Logged-In value 406 to indicate that the user is currently logged in to server 220. In contact card 414, info ID field 413 is populated with a unique identifier for contact card 414, name field 415 is populated with the first and last name provided by the user and email field 419 is populated with the email address provided by the user. In addition, photo field 418 contains the photo uploaded by the user during registration.

FIG. 8 provides a user interface 800 showing an email login page that is displayed if the user selects to login using an email account at step 516 of FIG. 5. In FIG. 8, sign-in tab 704 is shown to include an email text box 806 and password text box 808 that can accept an email and a password, respectively. User interface 800 also includes a sign-in control 810 that when activated causes the user to be logged in.

After a user record has been created at either step 524 or step 515, server 220 uses the information in contact card 414 to generate a profile page user interface at step 526. The profile page user interface allows a user to enter additional information or to edit the existing information at step 530, to add more social media services at step 532 by providing a social media username and to modify the user's photo at step 534 by uploading a different photo or selecting a different photo from a social media service. If additional social media services are added at step 532, server 220 requests permission to access the information available on the additional social media services at step 536. This can include accessing any address information stored in the social media site for the user.

At step 538, the user selects to save the updated profile information on the contact card 414. In accordance with one embodiment, this contact information is required to include at a minimum, a name, a title, a company, a photo and at least one form of contact information that can be used to communicate with the user. After the contact card information is saved or after login steps 516 and 518 of FIG. 5, application 340 sends the RFID value of all devices that are in proximity to device 204 to server 220 at step 539. In response, the server returns images of users of those devices that are then displayed in a homepage user interface on device 204 at step 540.

FIG. 9 provides a flow diagram of a method performing step 539 to send the RFID values of devices that are in proximity to device 204 and obtaining in return images of the users of those devices. In FIG. 9, the device that detects and sends the RFID values and displays the images is referred to as the detecting device. A device that is in proximity to detecting device and is transmitting a wireless signal is referred to as the transmitting device.

In step 900, the detecting device receives a wireless signal from the receiving device. This wireless signal may take the form of a radio-frequency signal (RF signal). At step 902, the detecting device determines the unique identifier of transmitting device that is embedded in the received wireless signal. This unique identifier is typically associated with a particular protocol, such as the Bluetooth protocol. In accordance with one embodiment, the wireless signal is a low energy Bluetooth signal. However, other wireless signals, both radio-frequency signals and non-radio-frequency signals, may be used if they include a unique identifier for the device transmitting the signal. At step 904, the detecting device, such as device 204, sends the unique identifier of the transmitting device, such as device 210, to a module in server instructions 380 on server 220.

At step 906, server instructions 380 search device records 400 of each user record 382 to determine if the RFID value in the device RFID field 403 matches the unique identifier of the transmitting device. Note that in some embodiments, a single user record may have multiple device records 400 if the user uses multiple devices to access server 220. In addition, the user may be logged into server 220 through multiple devices at the same time.

If server instructions 380 are able to find the unique identifier in a device RFID field 403, server instructions 380 determines if a SHOW PRESENCE flag 408 in device records 400 is set to true at step 908. The SHOW PRESENCE flag defaults to a true state and in the true state indicates to server 220 that the user wishes to have their image shared when the device RFID 403 is detected. If SHOW PRESENCE flag 408 is set to false, server 220 will not share an image of the user with other devices even if device RFID 403 is detected.

When server instructions 380 determine that SHOW PRESENCE flag 408 is true, server instructions 380 retrieves an image of the user from a default contact card 414 at step 910. In particular, server instructions 380 retrieve the image listed in photo field 418 of the default contact card 414. In accordance with some embodiments, the user may designate which contact card is to be used as the default contact card if there are multiple contact cards defined for the user. Without further user designation, the first contact card created when the user registered with server 220 is used as the default contact card.

At step 912, server instructions 380 return the image retrieved from photo field 418 to the detecting device. At step 914, the detecting device displays the image and a control for sending information to the transmitting device 2 using the displayed image.

The steps of FIG. 9 are repeated for each wireless signal detected by the detecting device. As additional images are returned by server 220, the transmitting device modifies a homepage user interface to include the other images, by for example, shifting or changing the size of photos currently displayed or shifting images to additional pages that can be accessed using a swipe gesture on the homepage.

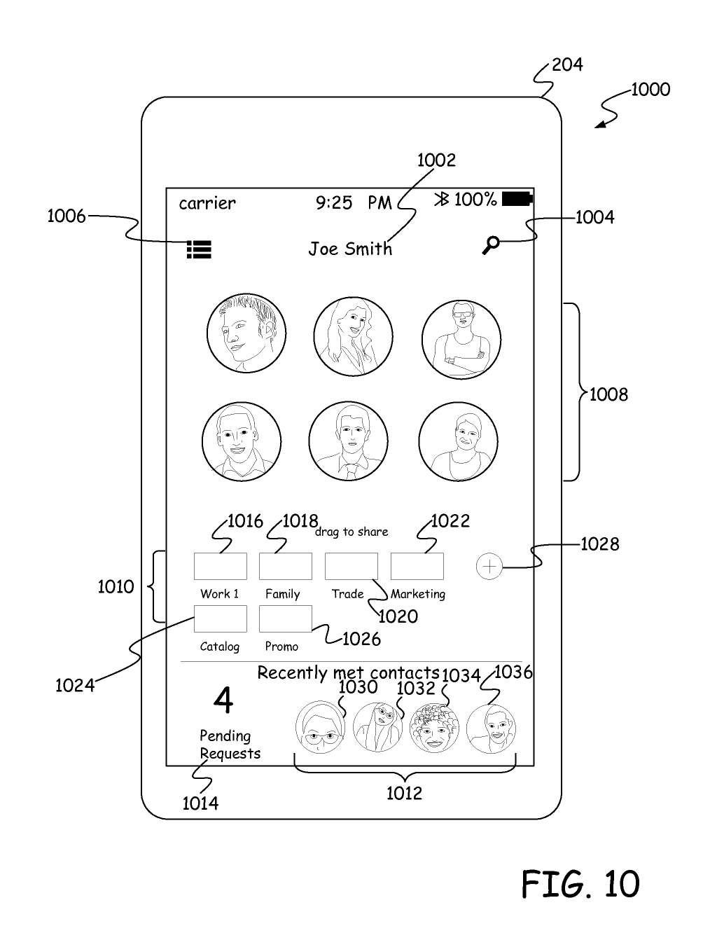

FIG. 10 provides an example of a homepage user interface 1000. User interface 1000 includes a user name 1002, a search control 1004, a list control 1006, a people nearby area 1008, an information set 1010, a recently met contacts area 1012 and a pending requests control 1014.

Name 1002 indicates the name of the user of device 204, search control 1004 activates a search page described further below, and list control 1006 provides a list of nearby users. Nearby user area 1008 provides images of users that have been determined to be nearby using the process of FIG. 9 above. Additional images of nearby users may be retrieved using a swiping gesture, either to the left or to the right, over area 1008.

Information sets 1010 provide icons representing collections of information to be shared with nearby users. These icons can represent collections of contact information with different icons representing different contact information. For example, Work 1 icon 1016 can contain standard work contact information, Family icon 1018 can represent information for contacting the user at home, Trade icon 1020 can represent contact information that is to be handed out at a trade show, and Marketing icon 1022 can represent contact information that is to be handed out during marketing events or sales calls. In addition, icons can be provided for product description information, such as Catalog icon 1024 or advertising information, such as Promo icon 1026. An add icon control 1028 is provided for creating new information to share.

Recently met contacts area 1012 includes a collection of image controls, such as images 1030, 1032, 1034 and 1036 that represent users who have shared information with the user of device 204. In accordance with one embodiment, an image is only added to recently met contacts area 1012 if the user of device 204 has accepted at least one piece of information from the person associated with the image. If the user of device 204 has received information from another user but has not indicated whether they are going to accept the information, the information appears as one of the pending requests 1014. When there are no pending requests, the space occupied by pending request control 1014 in FIG. 10 is filled by expanding the recently met contacts area 1012 so that an additional image of a user who has shared information may be included on display 1000. Recently met contacts are displayed in recently met contacts area 1012 with the most recent contact on the left and earlier contacts displayed to the right. Additional recently met contacts may be discovered by swiping left or right over recently met contacts area 1012.

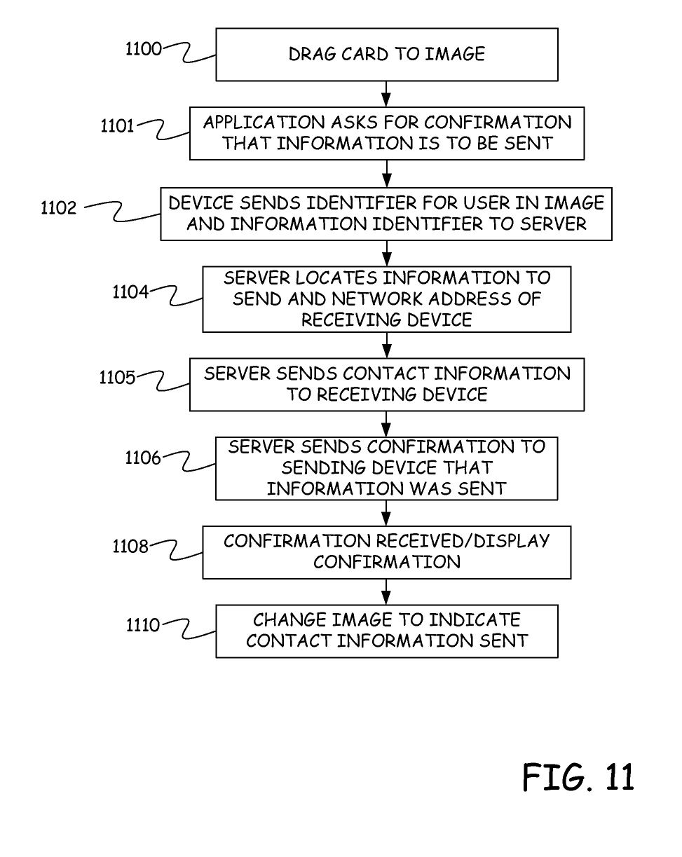

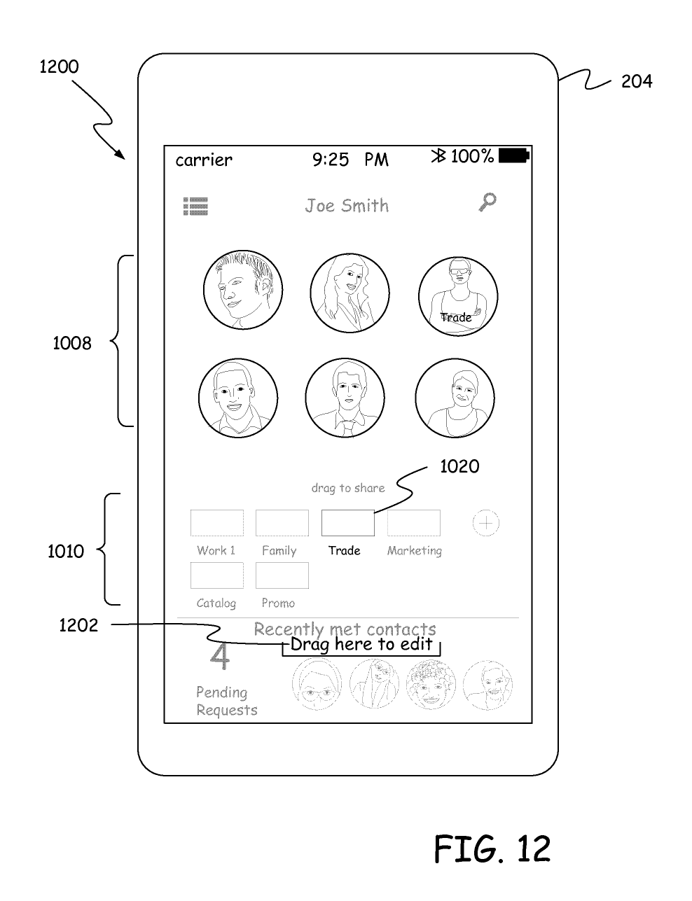

FIG. 11 provides a method for requesting that information be sent to a nearby user. At step 1100, the user drags an icon from information set 1010 to an image in nearby users 1008. FIG. 12 shows a user interface 1200 that is created when the user touches icon 1020 in information set 1010. In user interface 1200, items other than icon 1020 and photos in nearby users 1008 are blurred and a “drag here to edit” control 1202 is added. If the user drags icon 1020 into “drag here to edit” control 1202, an edit page will be opened that will allow the user to change the information associated with icon 1020 by altering, removing, or adding more information.

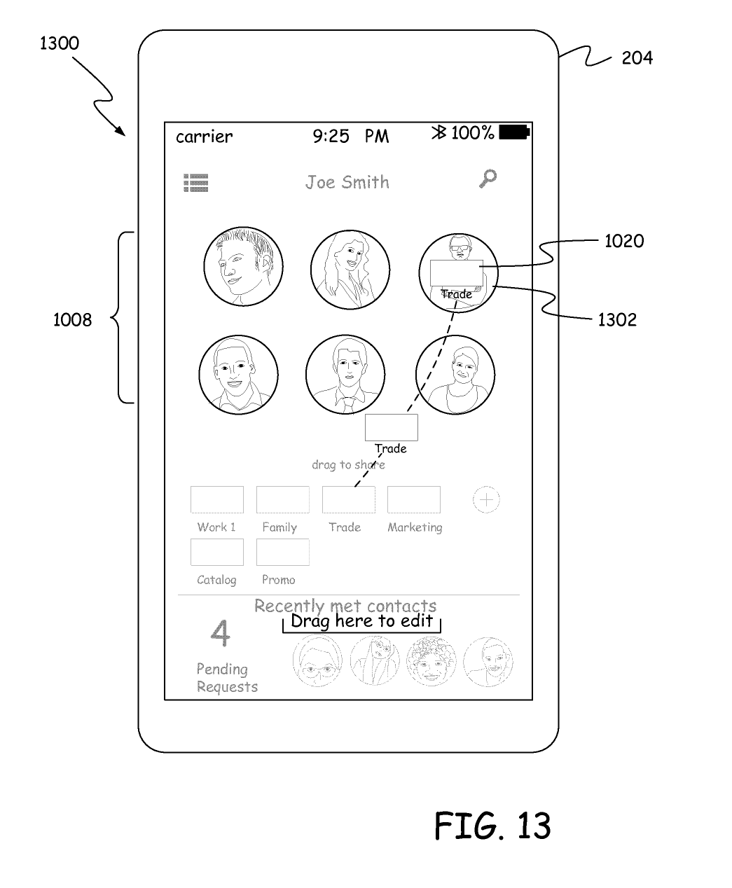

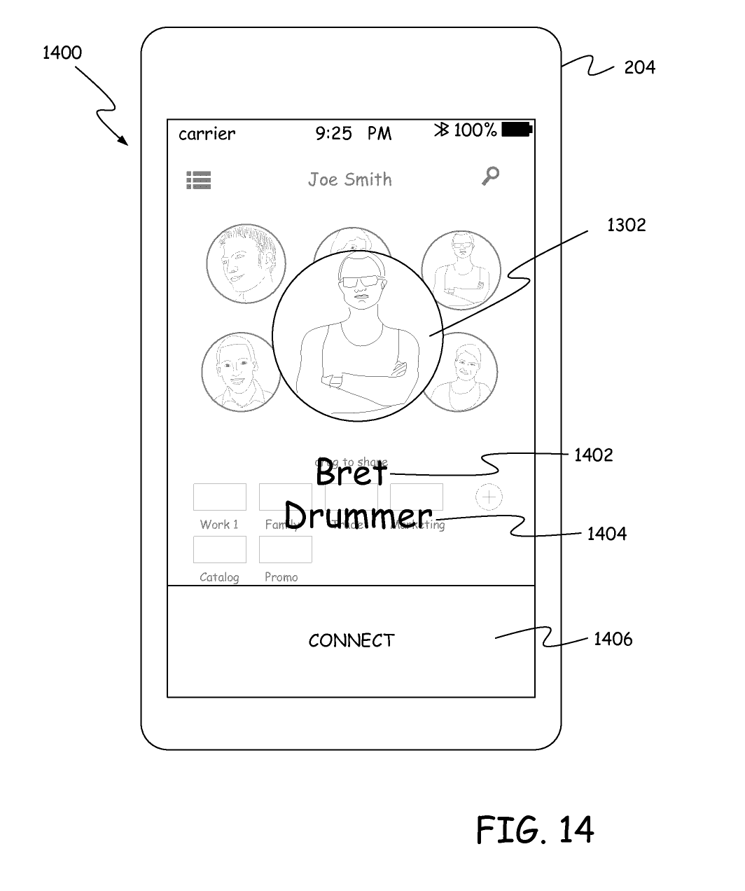

FIG. 13 provides a user interface 1300 showing an animation produced as the user drags icon 1020 to image 1302 in nearby users 1008. When the user has dragged icon 1020 to image 1302, the user releases icon 1020, thereby indicating to application 340 that the user wants server 220 to send the information associated with icon 1020 to the user associated with image 1302. At step 1101, application 340 displays user interface 1400 of FIG. 14 to ask the user to confirm that they wish to send information to the user associated with image 1302. User interface 1400 includes image 1302 in an enlarged format as well as a name 1402 and a title 1404 of the user associated with image 1302. User interface 1400 also includes a connect control 1406 that the user must select to confirm that they want server 220 to send information to the person depicted in image 1302.

After the user has confirmed that they wish to send the information associated with the icon to the user depicted in the image at step 1101, application 340 sends a request to a module in server instructions 380 to have the information sent to the user. In the request, application 340 includes an identifier for the user associated with the image. This identifier can be the unique device identifier detected by device 204 or can be another identifier provided by server 220 when server 220 returned the image of the user to device 204. The request also includes an information identifier representing the information associated with the icon that was dragged onto the image. This information identifier can include an identifier of the user of device 204 and an identifier for a share information record 412 that contains the information to be shared. In accordance with one embodiment, each icon displayed in information set 1010 has a unique share information record that has a unique info ID, such as info ID 413 of contact card records 414, or similar info ID values in menu/catalog records 427 or Promotional records 428. Although only three types of information records are shown in FIG. 4, those skilled in the art will recognize that records for other types of information may be provided in share information 412. A contact card record 414 will include various selected user information, such as the name, title, and company, as well as contact information for interactive communications such as phone numbers, email, social media usernames and addresses of the user. Menu/catalog cards 427 will include information for ordering products/services that are for sale including a name of the product, a description of the product, an image of the product, a video of the product and a price of the product, for example. Promotional cards 428 will include information regarding a particular promotion including the product or service that is the subject of the promotion, a regular price, and a sales price.

At step 1104, server instructions 380 use the information identifier to retrieve the share information card 414. Server instructions 380 also use the identifier for the user that is to receive the information to retrieve a network address 404 for a device associated with that user. Thus, server instructions 380 uses a user record 382 of the user that is requesting to send the information to retrieve the information that is to be sent and accesses a user record 382 of the user who is to receive the information to determine the network address of the receiving user. At step 1105, server instructions 380 send the information identified by the sender to the network address of the receiving user. At step 1106, server instructions 380 send confirmation to the sending device that the information has been sent. At step 1108, the sending device receives the confirmation and displays confirmation to the user in a page that appears momentarily and then disappears by itself. In some embodiments, an additional step 1110 is performed to change the image on homepage 1000 after the information has been sent so that the user who sent the information does not mistakenly resend the information to the same user. For example, the border around the image of a user that has already received information can be changed to indicate the type of information sent to the user. Thus, a first color border can be associated with a first icon from information set 1010 and a second color border can be associated with a second icon from information set 1010.

In the method of FIG. 11, the user of device 204 is able to share contact information with people displayed on the user interface of device 204 before receiving contact information from the people displayed on the user interface. Further, the method of FIG. 11 and the associated user interfaces do not provide the ability to share contact information with people who are not displayed on the user interfaces. Thus, the contact information is not being broadcast to many users but instead is being directed to particular users based on their proximity to device 204.

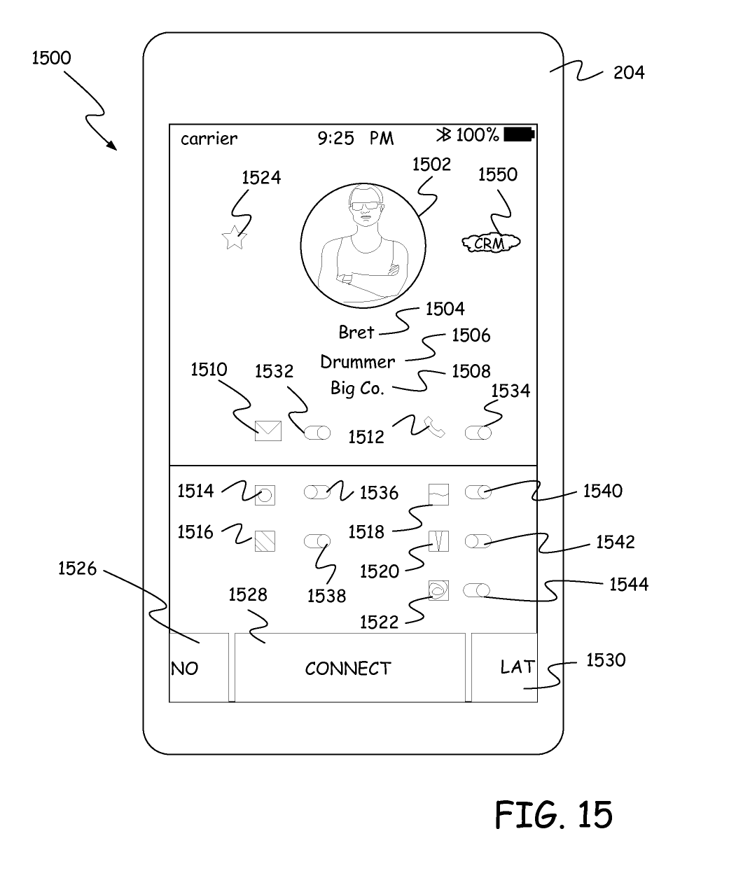

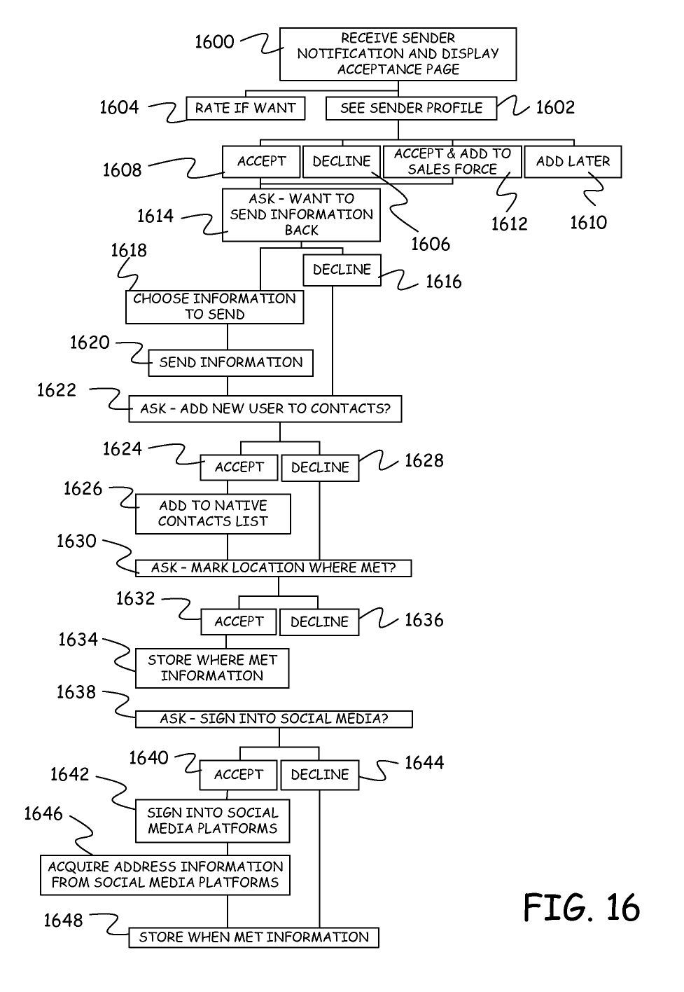

FIG. 15 provides an example of an information acceptance page 1500 that is produced when server instructions 380 of server 220 send information to the device based on a request from another device. FIG. 16 provides a flow diagram of a method that is executed when user interface 1500 is displayed. In step 1600, a request from server 220 to accept contact information associated with a user of device 210, also referred to as a sender notification, is received by device 204. Based on the sender notification, device 204 displays acceptance page 1500. In acceptance page 1500, the user can see the sender's profile at step 1602 including the sender's photograph 1502, their name 1504, their title 1506, their company 1508, as well as the types of information that the sender is attempting to share including such information as email 1510, phone numbers 1512 and social media user names, such as social media user names 1514, 1516, 1518, 1520 and 1522. At step 1604, the user may rate the sender of the information using a rate control 1524, which takes the form of a star in one embodiment. By sequentially tapping on control 1524, the user is able to assign one of multiple ratings to the sender to indicate the importance of the sender's information. In accordance with one embodiment, up to five different rating levels are provided. At the bottom of user interface 1500 are three controls: 1526, 1528 and 1530. Control 1526, which can be viewed in its entirety by making a swiping gesture to the right, includes the word “NO” and can be used to decline all of the information at step 1606. If a user declines the information, user records 382 on server 220 are not updated with the sent information. Control 1528 includes the word “CONNECT” and can be used to accept some or all of the information at step 1608. If the user accepts the information, user records 382 are updated by adding a contacts record 460 and filling the fields of the contacts record 460 with the accepted information. Control 1530 includes the word “LATER” and can be seen in its entirety by making a swiping gesture to the left. Selecting control 1530 causes the decision to accept the information to be deferred at step 1610 and the deferred decision remains a pending request.

Before accepting the information, the receiver of the information can designate which of the sent items of information they wish to receive using controls, such as slide controls 1532, 1534, 1536, 1538, 1540, 1542 and 1544. In one position, each of the controls 1532-1544 indicates that its respective information is to be accepted and in a second position, each of the controls indicates that its respective information is to be declined. For example, by sliding control 1532 to the left, the user can indicate that they wish to accept email address 1510 of the sender and by sliding control 1532 to the right, the user can indicate that they wish to decline email address 1510. Note that the user decides whether to accept or decline the information before seeing the content of the information.

As an alternative to using connect control 1528 to accept the information, the user can use CRM control 1550 to indicate at step 1612 that the information should be accepted and should be added to a customer relations management server 360 that may be accessed either by server 220 or by devices 204, 210 through network 320. CRM server 360 includes a memory 364 that can store some or all of the information provided by the sender in one or more databases including a leads database. When the information is stored in a leads database, the person who received the information is designated in the CRM server 303 as the person responsible for obtaining the lead.

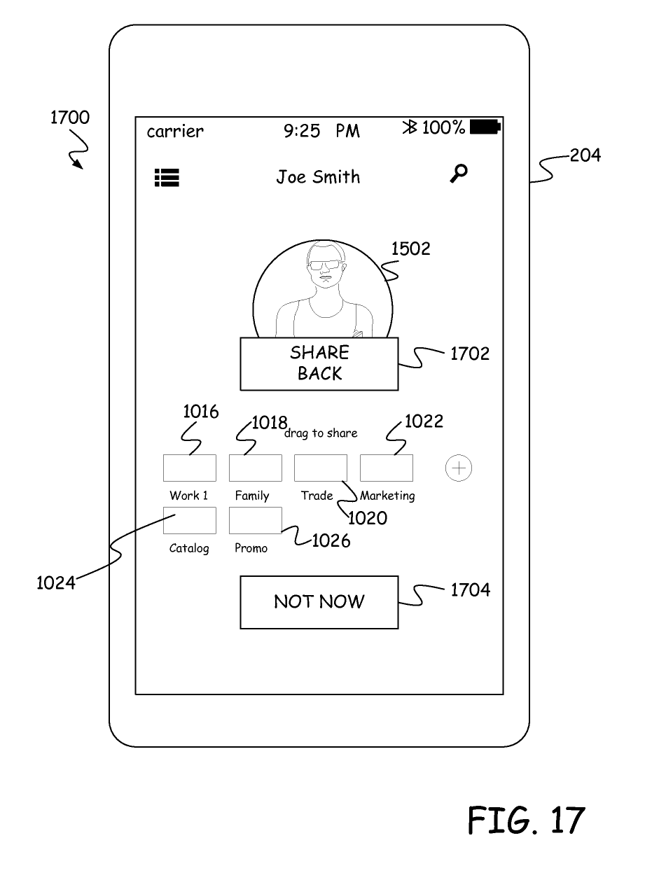

If the user accepts any of the information sent by the sender, user interface 1700 of FIG. 17 is provided to the user that includes photo 1502 of the sender, a send back control 1702 and a “not now” control 1704. User interface 1700 represents a step 1614 of asking the user whether they want to send information back to the sender. If the user does not want to send information back at step 1616, the user selects “not now” control 1704. If the user wishes to share information, they select the information to share by dragging one of information cards 1016, 1018, 1020, 1022, 1024, and 1026 to share back control 1702 and then releasing the card over the control at step 1618. In response, device 204 sends a request to server 220 to send the selected information back at step 1620.

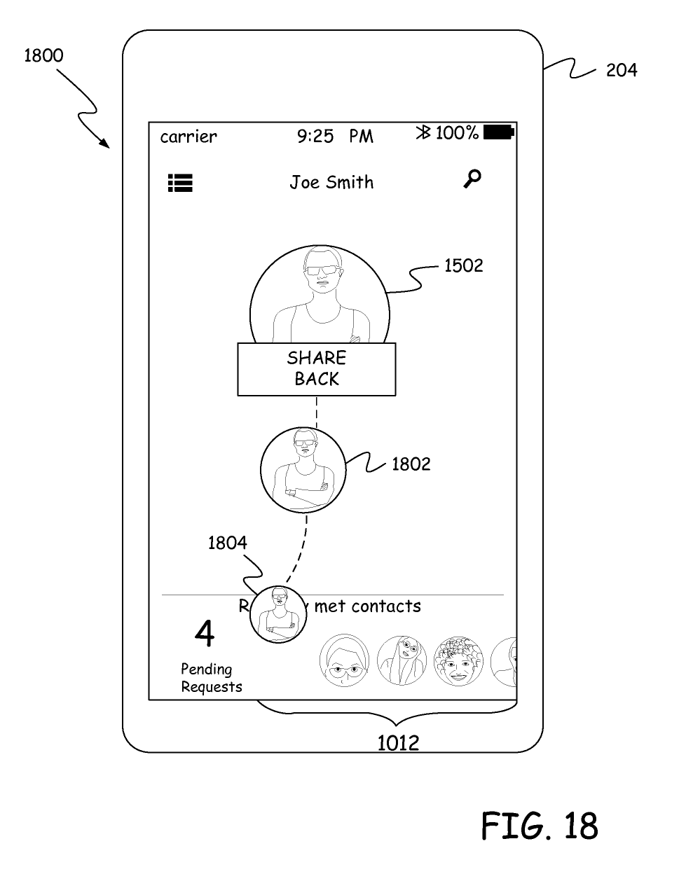

Regardless of whether the user chooses to send information back, a user interface 1800 is displayed on device 204 showing an animation in which the image of the sender decreases in size and moves down to recently met contact area 1012. Existing images in recently met contacts area 1012 shift to the right to make room for the image, which takes the leftmost position of the recently met contacts thereby indicating that this is the most recently obtained information on device 204. In FIG. 18, three portions of the animation are shown with the initial image 1502, a smaller secondary image 1802 and a third even smaller image 1804. Those skilled in the art will recognize that additional frames of the animation are present to provide a smooth movement of the image from its initial position to its final position as well as to provide a smooth change in the size of the image.

Returning to FIG. 16, if the user has not previously provided application 340 with the rights to alter a native contacts list 348 in memory 302, application 340 asks the user at step 1622 whether the user will allow application 340 to modify native contacts list 348. If the user allows application 340 to modify native contacts list 348, application 340 will store the information provided by the sender in the native contacts list at step 1626. Regardless of whether the user allows application 340 to modify native contacts list 348 at step 1624 or refuses at step 1628, information sent by the sender is stored in user records 382 for the user who received the information. In particular, the information is stored in contacts record 460, which includes various types of information that users are able to send to each other including the name of the user 461, their title 462, their company 463, their photo 464, their email address 465, their mobile phone 466, their home phone 467, their work phone 468, their social media user names 469, 470, their home address 473, and their work address 474.

At step 1630, application 340 asks the user whether application 340 can access location information on device 204 in order to store the location of device 202 where the user either received contact information or accepted the contact information. If the user allows access to the location information at step 1632 or if the user has previously allowed access to the location information, the location information is stored as “where met” information 476 in contact record 460 on server 220. This information is stored at step 1634. If the user declines access to the location information at step 1636, the information of where device 204 was located when the contact information was received or accepted is not stored.

At step 1638, application 340 examines any of the social media usernames provided by the sender and determines whether the user is currently signed into the social media platforms associated with those addresses. For each social media platform that the user of device 204 is not signed into, application 340 asks for permission to sign in to the social media platform at step 1638. If the user accepts this request at step 1640, the sign-in API for the social media platform(s) is called to allow the user to sign-in at step 1642. If the request is refused at step 1644, the user is not signed into that platform.

At step 1646, application 340 requests access to the public information stored for the sender's username on the social media platform. In various embodiments, this is referred to as following, friending or linking to another user. Once application 340 has been given access to this public information, application 340 parses the information to identify physical addresses or location information stored on the social media platform for the sender of the information. This location information can be general, such as a country or state or can be specific, such as a street address. Application 340 sends the social media location information to server 220, which stores it in under contacts 460 as social media addresses 471. 472. At step 1648, server 220 stores the date and time at which the information was either sent to the recipient or the time and date at which the information was accepted by the recipient as “when met” data 475.

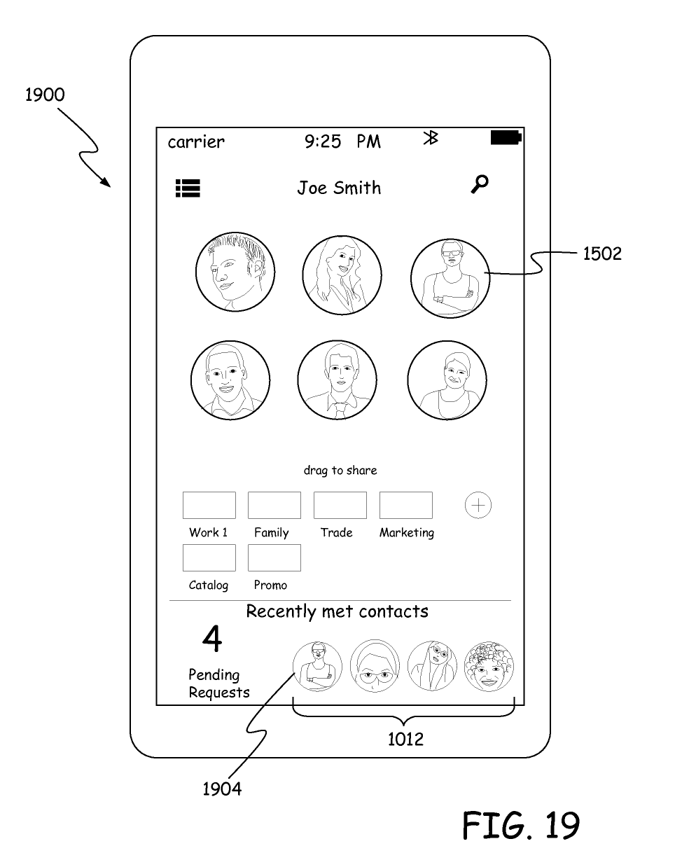

FIG. 19 provides a user interface 1900 showing the appearance of the homepage after the information associated with image 1502 has been accepted causing a smaller version of the image 1904 to appear in the recently met contacts area 1012.

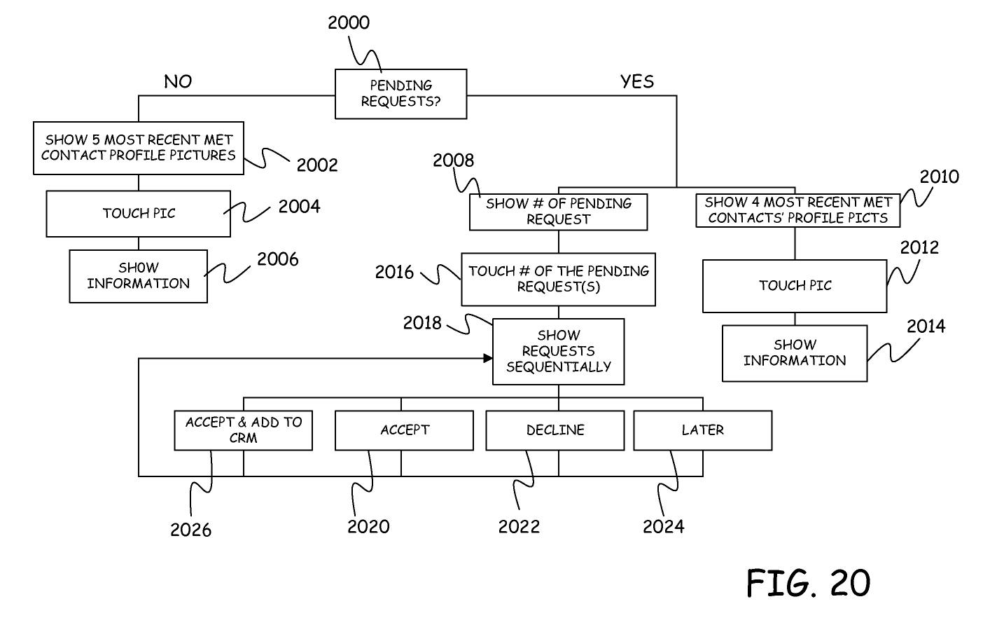

FIG. 20 provides a flow diagram for producing recently met area 1012 and pending request control 1014 of FIG. 10. If there are no pending requests at step 2000, the five most recently met contacts are displayed and pending request control 1014 is not displayed at step 2002. Thus, recently met contacts 1012 fills the entire bottom space if there are no pending requests. If the user touches on a picture at step 2004, the user will be shown the information sent by the contact at step 2006.

If there is a pending request at step 2000, the number of pending requests is shown in pending request control 1014 at step 2008 and the four most recently met contacts are shown next to the pending request control at step 2010. If the user selects an image of one of the four most recently met at step 2012, the information sent by that user is provided at step 2014.

If the user touches pending request control 1014 at step 2016, the requests are shown sequentially at step 2018 and in accordance with one embodiment, take the form of the request shown in FIG. 15 whereby the user is allowed to accept the request as shown by step 2020, decline the request as shown by step 2022, defer the request so that it remains a pending request at step 2024 or accept the request and add it to a CRM database as shown by step 2026. After a user has accepted, declined or postponed accepting the sent information, the next pending request is displayed to the user or if there are no further pending requests, the user is returned to the homepage.

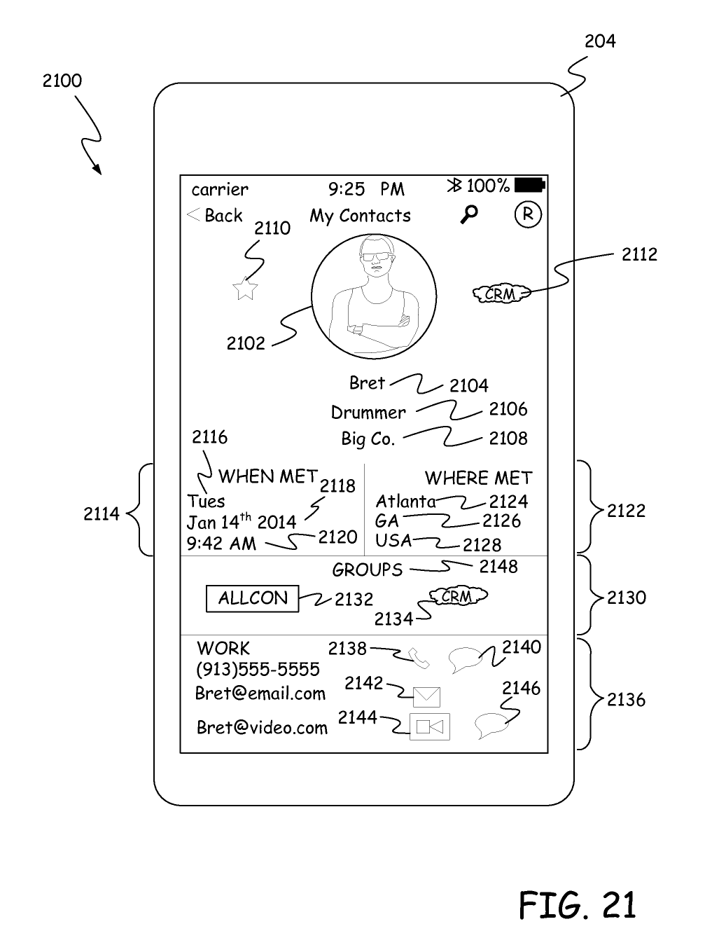

FIG. 21 provides an example of a user interface 2100 providing information sent by a sender that is displayed when a user requests to see that information, by for example, selecting the sender's image from recently met contact area 1012 of FIG. 10. User interface 2100 includes an image 2102, name 2104, title 2106 and company name 2108 for the sender of the information. User interface 2100 also includes a rating 2110 that may be changed by tapping on rating 2110. User interface 2100 also includes a CRM indicator 2112 that indicates whether this information has been stored in a CRM database.

User interface 2100 includes “when met” information 2114 that indicates the day 2116, date 2118 and time 2120 when either this contact information was provided to the user of device 204 or when a user of device 204 accepted the information. User interface 2100 also includes “where met” information 2122 that includes, for example, a city 2124, a state 2126 and a country 2128, where device 204 was positioned either when the contact information was received or when the contact information was accepted. More precise “where met” information 2122 may be provided including an exact street address, longitude and latitude information, or site information, such as the name of a convention center, a sport's stadium, a restaurant, or a bar.

If the person in user interface 2100 has been assigned to a group, the icons for the groups are displayed in a groups section 2130, such as icons 2132 and 2134. Icon 2134 indicates that this user is in a CRM group meaning that the user's information has been stored in a CRM database.

User interface 2100 also includes a contacts area 2136 that provides various means for contacting the person shown in user interface 2100 based on the information provided by that user and stored in contacts record 460 of server 220. Such contact channels can include, for example, voice 2138, text 2140, email 2142, video conferencing 2144 and Internet-based texting 2146.

Any of the fields shown in user interface 2100 may be edited by clicking on the information and correcting the information in a text box, which will appear when a field is selected. If the user of device 204 wishes to change the groups that this contact is assigned to, they may select Group control 2148. Any changes made to the fields or groups through user interface 2100 will be reflected in the native contact lists 348 and on contact record 460 of server 220. Additionally, the information may be changed in the CRM server 360.

If the user wishes to contact the person described by user interface 2100, they may select one of the controls, such as voice control 2138, text control 2140, email control 2142, video conferencing control 2144 and Internet text control 2146 to activate an application that will permit communication along the selected channel. For example, selecting voice control 2138 will invoke a dialer application and will cause the dialer application to automatically dial the phone number associated with the voice control. Similarly, text control 2140 will cause a text editing application to open with a text addressed to the phone number and email control 2142 will cause an email application to open with an email template started that is addressed to the email address of the person shown on user interface 2100. Similarly, video conferencing control 2144 will cause a video conferencing application to open and to connect to the username defined next to the video conferencing control. If Internet texting control 2146 is selected, a text box for sending text to the username identified next to the control is opened.

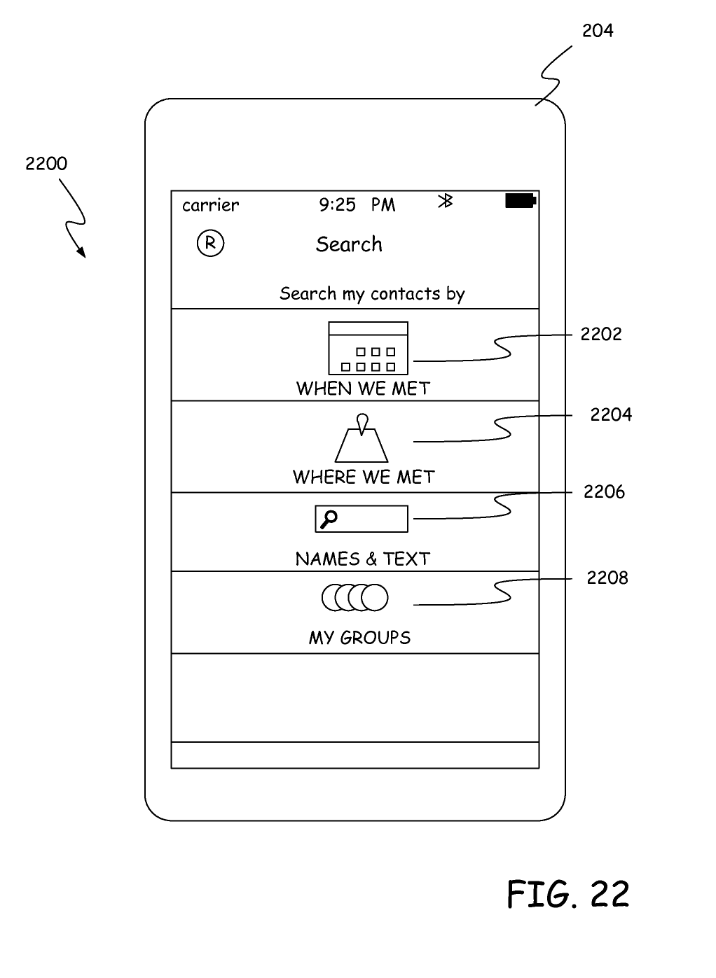

FIG. 22 provides an example of a user interface 2200 that is provided in response to a user selecting search control 1004 of FIG. 10. In one embodiment, search control 1004 is found on numerous user interfaces associated with application 340 to allow quick access to user interface 2200. User interface 2200 provides numerous ways to search for a contact including searching by “when” the contact was met 2202, by “where” the contact was met or can be found 2204, by text associated with the contact 2206 or by groups to which the contact was assigned 2208.

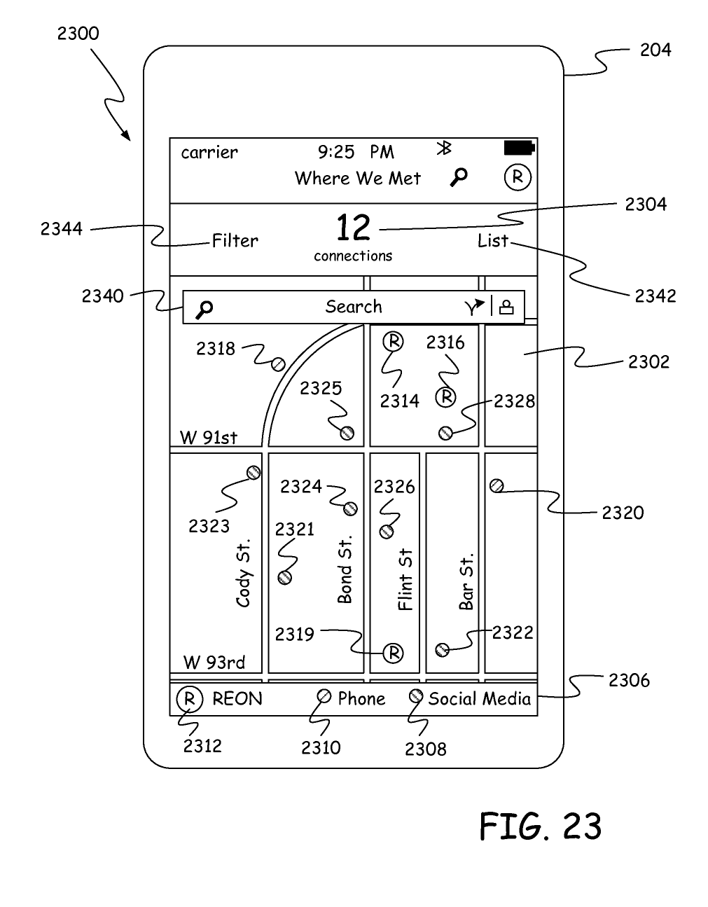

If the user selects control 2204 to search “where” the contact was met or where the contact can be found, user interface 2300 of FIG. 23 is provided. User interface 2300 provides a map 2302 centered on the user's current location. On map 2302, a collection of selectable icons are displayed where each icon represents a location associated with a contact in contact records 460 for the user of device 204. The number of icons is shown as connection number 2304. A key 2306 indicates the different types of addresses that the icons represent including a social media icon 2308, a native phone list icon 2310 and a REON icon 2312. Social media icons 2308 represent addresses taken from social media platforms for contacts as described above and as found in social media addresses 471, 472 in contacts 460. Native phone icons 2310 represent addresses found in native contacts list 348 on device 204. REON icons 2312 represent icons designating a location where device 204 was when it either received the contact information for another user or where device 204 was when the user of device 204 accepted the information from the contact. Thus, on map 2302, icons 2314, 2316, and 2319 each represent locations where the device as when contact information was either received or accepted. Icons 2318 and 2320 represent addresses found in native contact list 348. Icons 2321, 2322, 2323, 2324, 2325, 2326 and 2328 represent addresses pulled from social media for contacts in contact records 460.

Map 2302 may be zoomed in or out using either a pinched gesture or an expand gesture and may be translated horizontally, vertically or any other direction in order to view different parts of the map. As the map is changed, the number of contacts shown in the map will change and contacts number 2304 will be altered to reflect the number of icons shown on map 2302.

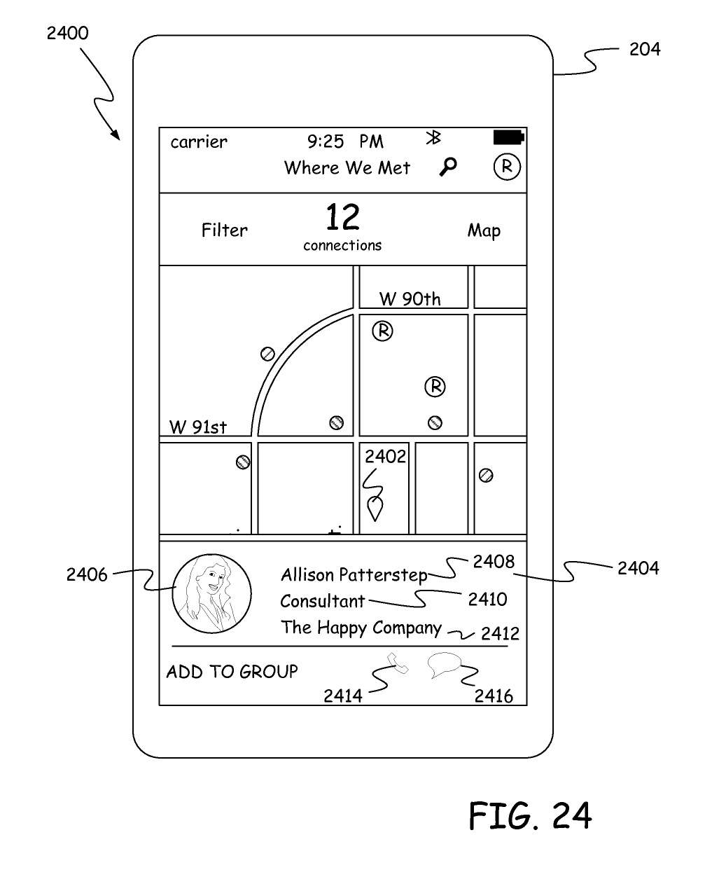

If a user selects one of the displayed icons on map 2302, the selected icon changes to a pin 2402 as shown in user interface 2400 of FIG. 24. In addition, the contact information for the person associated with the icons appears in a drawer 2404 that slides up from the bottom of the display. This information includes the person's photo 2406, their name 2408, their title 2410 and their company 2412 as well as contact buttons 2414 and 2416, which for example can be a voice contact or a text contact to allow the user of device 204 to initiate contact with that person. Although voice and text are shown, those skilled in the art will recognize that other communication channels may be facilitated in drawer 2404 to allow the user to contact this person through other communication channels.

Returning to FIG. 23, a search text box 2340 is also provided that allows a user to enter the names of locations that the user would like to search. When the user selects search box 2340, user interface 2500 is provided that displays the five last searches 2502 that were performed using search box 2340. The user may select to perform one of these past searches by selecting the displayed search. User interface 2500 also includes a text entry field 2504 that allows the user to enter a search term. Based on the search term, application 340 will generate a new user interface 2300 with map 2302 centered on the search term. If the search term is ambiguous, application 340 will provide a disambiguation screen to disambiguate between possible meanings of the search term such as disambiguating between Paris, France and Paris, Tex.

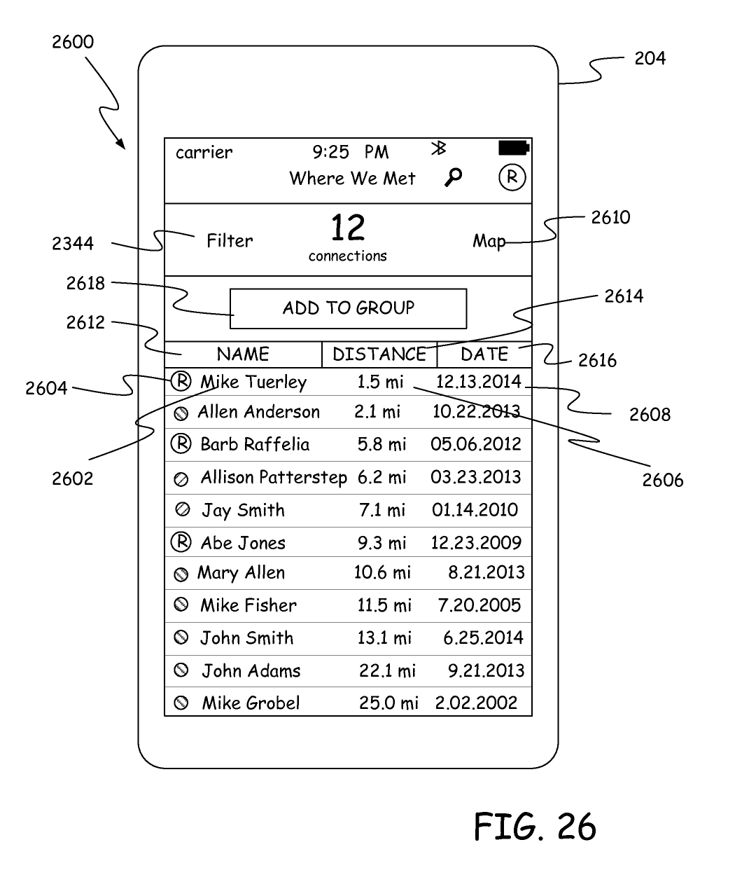

User interface 2300 also includes a list control 2342 that when selected causes user interface 2600 of FIG. 26 to be displayed. In user interface 2600, the contacts shown on map 2302 are listed showing their names, such as name 2602, their contact icon, such as contact icon 2604, the distance 2606 from device 204's current location to the address associated with the contact and the date 2608 that the contact information was either sent to device 204 or was accepted by device 204. User interface 2600 also includes map control 2610 to return the view to the view of user interface 2300. The list of names can be reordered using name control 2612, distance control 2614 and date control 2616. Each of the names, such as name 2602 is selectable and when selected causes the contact information, such as user interface 2100, for the selected user to be displayed. An ADD TO GROUP control 2618 causes a group user interface to be displayed which is described further below.

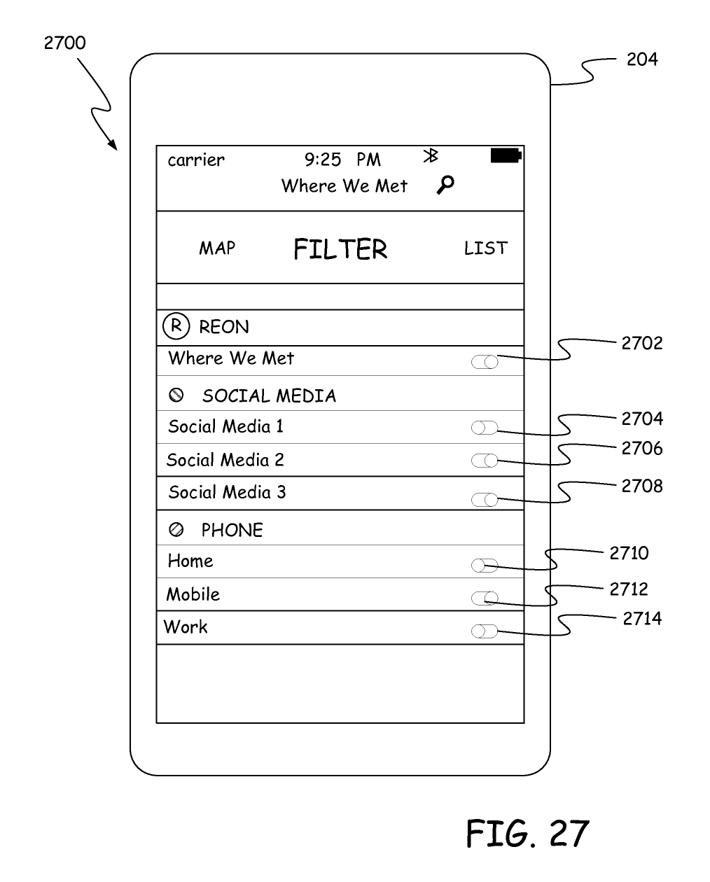

User interfaces 2300, 2400 and 2600 also include a filter control 2344 that when selected causes a user interface 2700 of FIG. 27 to be displayed. User interface 2700 allows the user to designate which address information should appear on map 2302 using controls 2702, 2704, 2706, 2708, 2710, 2712 and 2714. Control 2702 determines whether the REON addresses designating where contact information was received or accepted is displayed on the map. Controls 2704, 2706 and 2708 are each associated with a separate social media site and designate whether address information taken from that social media site will be displayed on map 2302. Control 2710 controls whether an address associated with a home phone number is displayed, control 2712 controls whether an address associated with a mobile phone number is displayed and control 2714 determines whether an address associated with a work phone number is displayed where each of the home, mobile and work phone numbers are found in the native contacts list 348. When one of the controls 2702-2714 is set to “off”, the associated icon does not appear in map 2302.

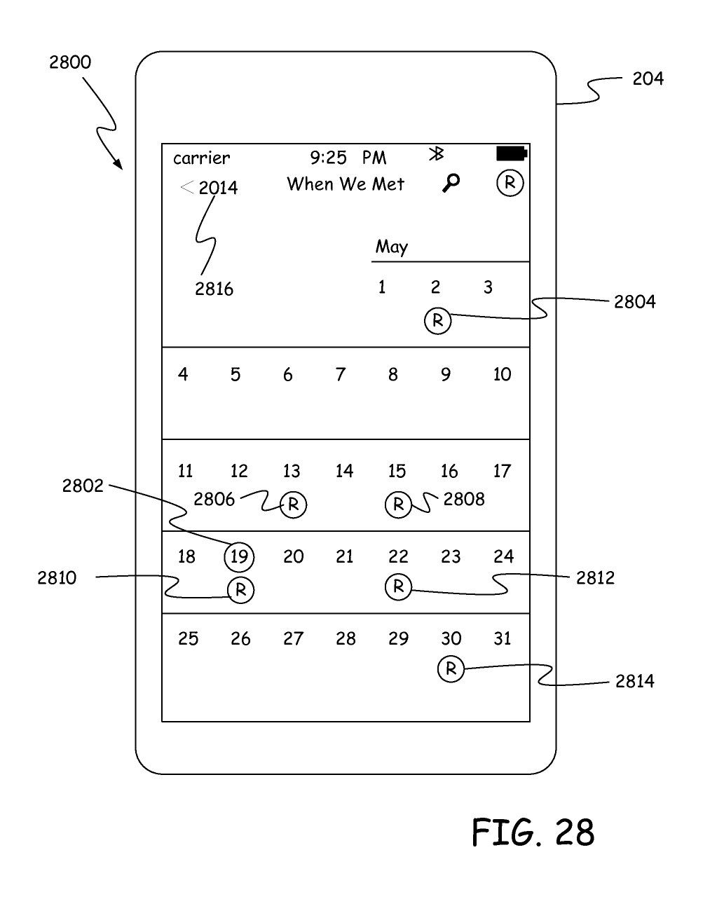

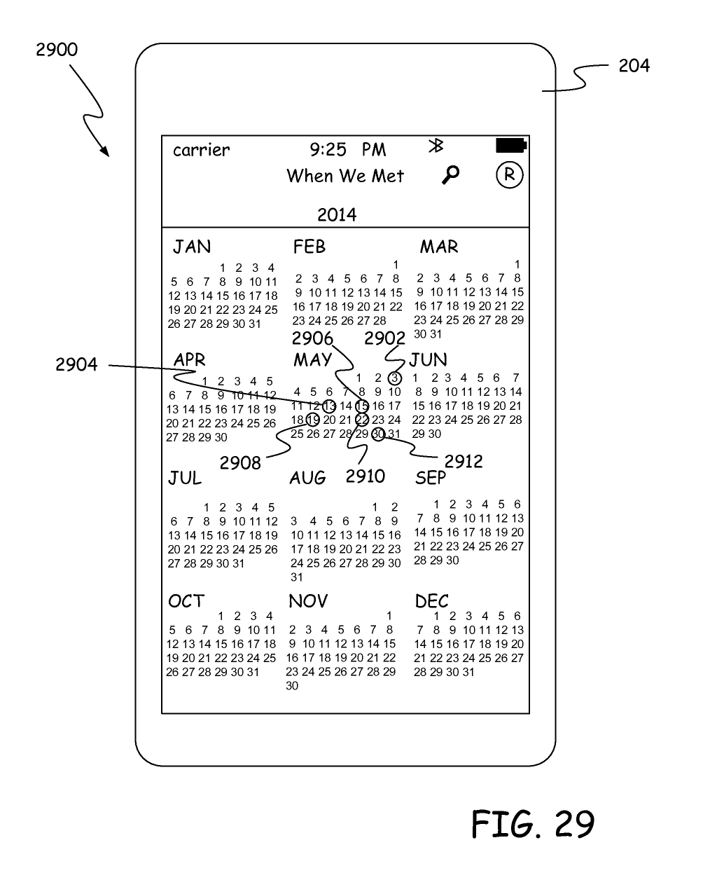

Returning to FIG. 22, when the user selects “when we met” control 2202, a month view calendar user interface 2800 of FIG. 28 is displayed. The month view calendar begins with the current month and highlights the current day using a highlighted icon 2802. Each date of the month during which contact information for at least one person was accepted on device 204 is shown with an icon, such as icons 2804, 2806, 2808, 2810, 2812 and 2814. The user may see the next month by swiping to the left or the previous month by swiping to the right. User interface 2800 also includes a year control 2816 that when selected causes user interface 2900 of FIG. 29 to be displayed. User interface 2900 shows a full year calendar and each date during which contact information was accepted on device 204 is highlighted. For example, user interface 2900 includes highlighted dates 2902, 2904, 2906, 2908, 2910 and 2912. To return to a month view, the user may tap on any of the months displayed. To go to the next year, the user may swipe to the left or to go to the previous year the user may swipe to the right.

If the user selects an individual day either within month view 2800 or within year view 2900, a list view 3000 is shown that displays the selected day and all the contacts accepted on that day as well as subsequent days and the contacts accepted on those subsequent days. The user may scroll through the contacts and the days by swiping upward or downward and may select a particular contact to bring up their contact information page, such as user interface 2100 of FIG. 21 by selecting the name of the contact. User interface 3000 also includes an ADD TO GROUP control 2002 that when selected brings the user to a group user interface described further below.

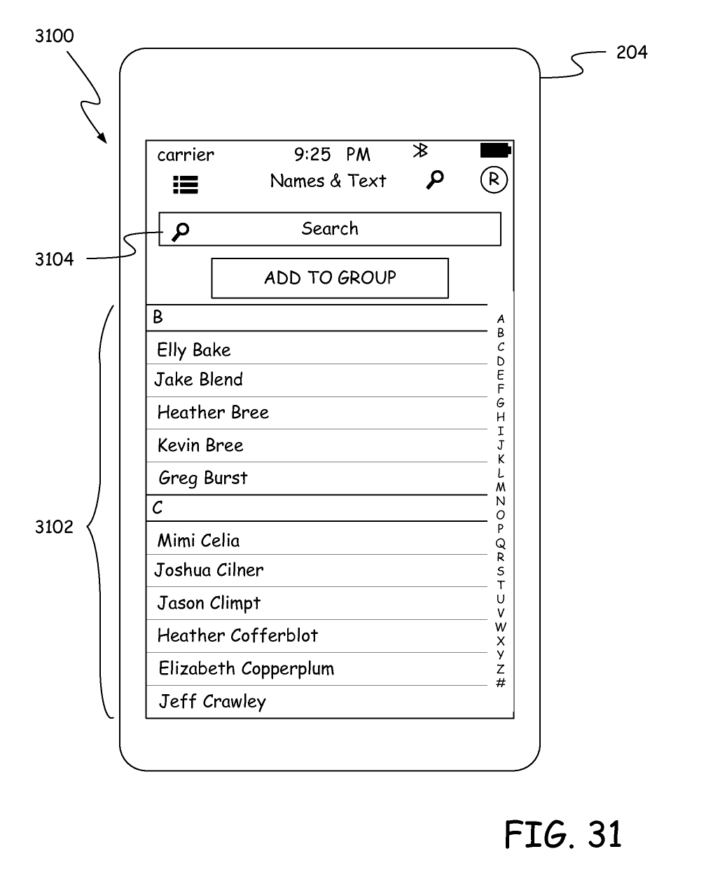

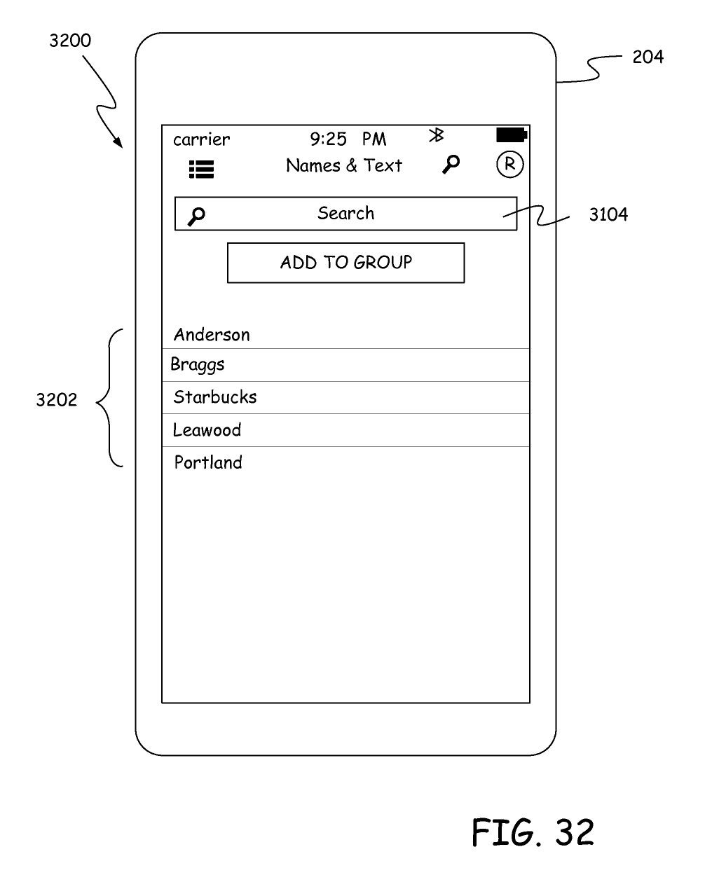

Returning to FIG. 22, if the user selects control 2206 to search based on text, they are provided with user interface 3100 of FIG. 31. User interface 3100 includes an alphabetical list 3102 of all contacts in contacts 460 of user records 382. User interface 3100 also includes a search text box 3104 that accepts text from the user. When the user taps on field 3104, user interface 3200 of FIG. 32 is initially provided that provides a list 3202 of the five most recent searches. The user may select any of these five most recent searches to perform that search again. If the user instead enters text in search box 3104, the five most recent searches are removed and the alphabetical listing 3102 of FIG. 31 is returned with only those items that match the currently entered search text. The search text is not limited to the names of the contacts but can include text of any field in contacts records 460. As a result, any contact that has any field that matches the text in search field 3104 will be shown in list 3102 and those that do not include matching information will be removed from list 3102. As a result, as text is entered, list 3102 will become shorter and shorter.

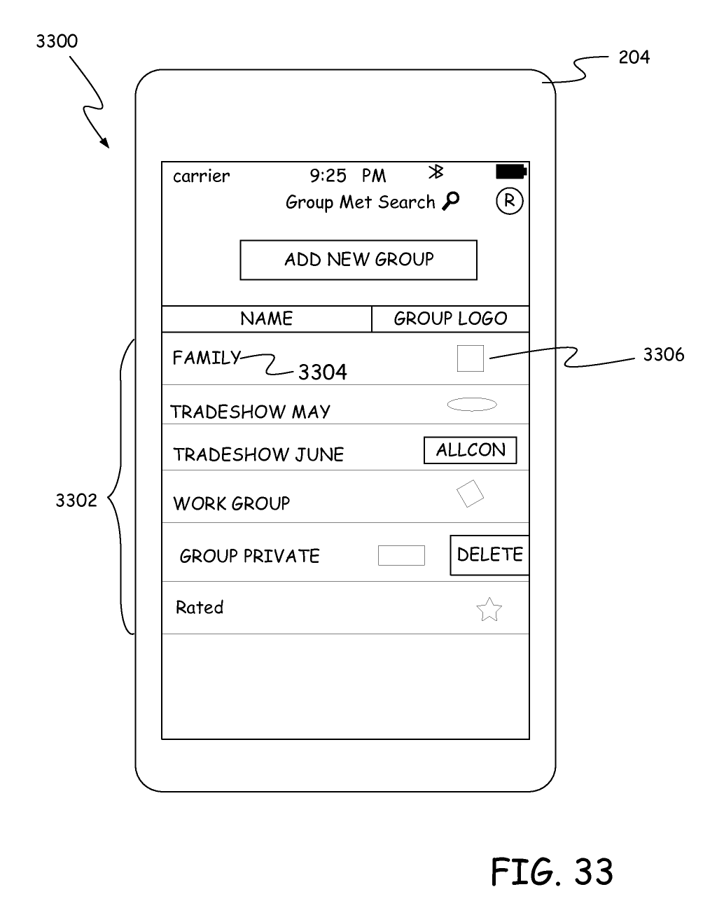

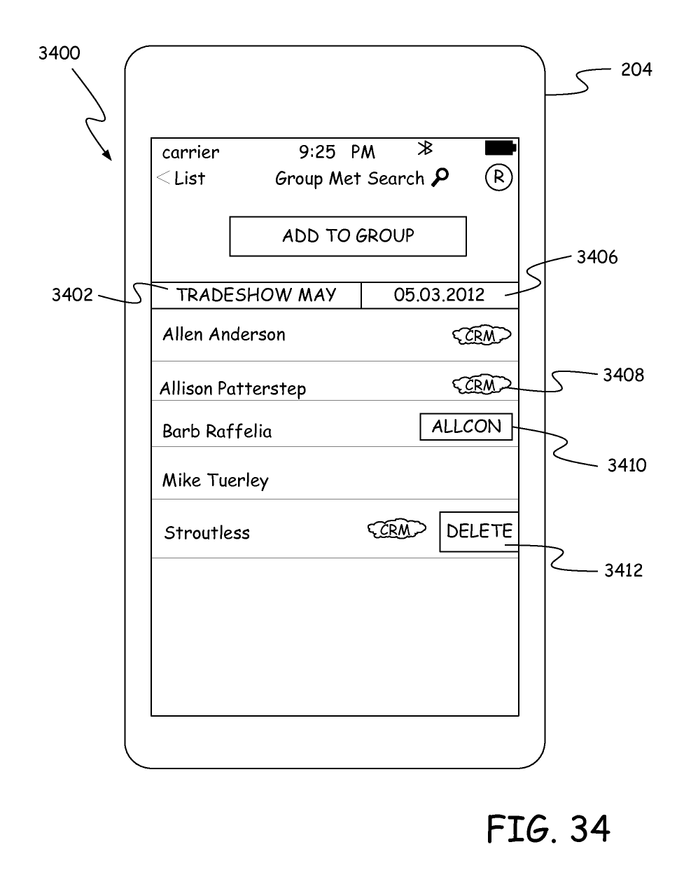

Returning to FIG. 22, when the user selects to search by groups, using group control 2208, user interface 3300 of FIG. 33 is displayed. User interface 3300 includes group list 3302 that includes groups that have been defined either in native contact list 348 or in groups records 470 of user records 382 of FIG. 4. Each record in groups records 470 includes a group identifier 431, a group logo 432, a group name or title 433, and a date when the group was created 434. In user interface 3300, the group name, such as group name 3304 and the group logo, such as logo 3306 of each group are shown. If a user selects a group name, user interface 3400 of FIG. 34 is displayed, which provides a list of the contacts that have been placed in the selected group. The selected group is identified by its name 3402 and the date when the group was created 3406. The names of the contacts that are in the group are found by searching contact record 460 for the group in a groups field 477. Additional groups that each contact belongs to can be shown in FIG. 34 by their icons, such as icons 3408 and 3410, which are placed in line with the name of the contact. The contact may be deleted by swiping to the left to expose a delete control 3412, which will remove the person from that group.

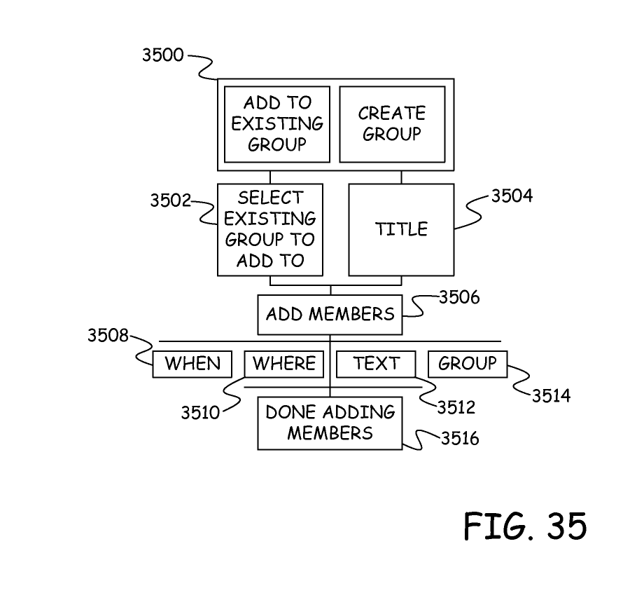

FIG. 35 provides a flow diagram of a method that is performed by application 340 when a user selects the ADD NEW GROUP button on any of the user interfaces described above. At step 3500, the user selects between adding members to an existing group or creating a new group. If the user is going to add members to an existing group, they select the existing group at step 3502. If the user is going to create a new group, they enter the title of the new group at step 3504. At step 3506, the user adds members to the group using a search page, such as user interface 2200 that allows the user to select members based on “when” 3508 their contact information was provided, “where” 3510 the device was when their contact information was received or accepted, text 3512 that is present in the contact information, or a group 3514 that the contact belongs to. The user is able to continue to add members in this way until they are finished adding members at which point they select a button to indicate they are done adding members 3516.

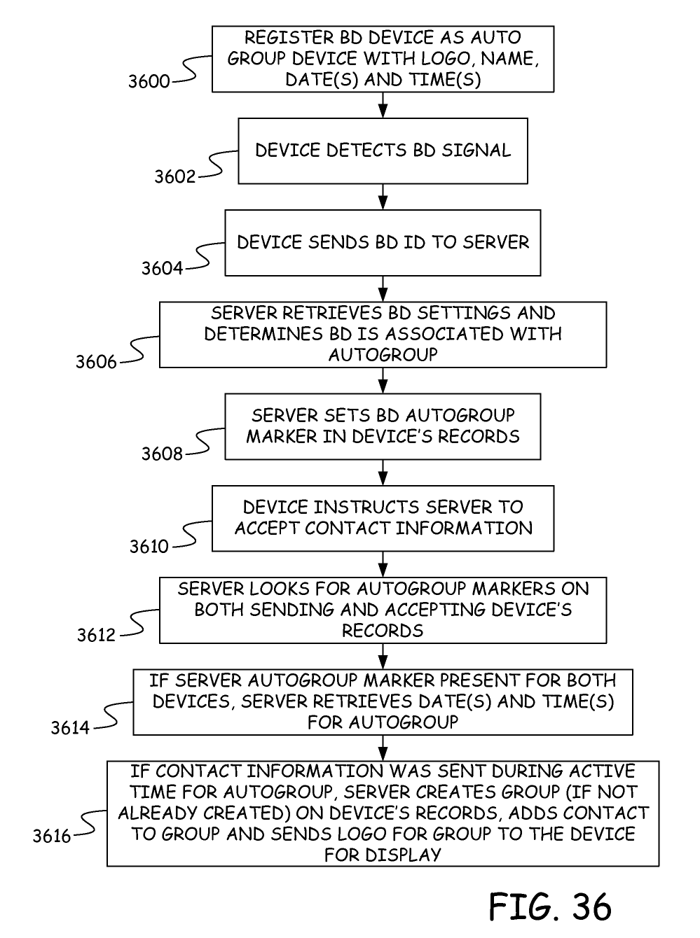

In accordance with some embodiments, application 340 and server 220 are able to place contacts in automatically generated groups based on whether the contacts were within range of a Broadcasting Device (BD) that has been registered to generate auto groups. FIG. 36 provides a flow diagram of a method for performing such auto grouping of contacts.

In step 3600, a broadcasting device (BD) is registered as an auto group device with server 220 by creating an Autogroup Record 486. The broadcast device, such as broadcast device 390 of FIG. 3, includes a radio-frequency transmitter 392 that transmits a unique radio-frequency ID 394 that can be received and decoded by RF transceiver 306 of devices 204 and 210. The RFID 394 of broadcast device 390 is stored as device ID 489 in device records 488 of Autogroup Record 486 when the broadcast device is registered with server 220. Each Autogroup record 460 also includes an Autogroup identifier 496, a Group Title 492, a Group Logo 492, and Active Date(s)/Time(s) 493. There is a separate device record 488 for each broadcasting device associated with this group and each device record includes the unique broadcasting id of the device 489 and a location designator for the area where the broadcasting device is expected to be operated.

At step 3602, a device, such as device 204 detects the broadcasting device signal. At step 3604, device 204 decodes the unique identifier of the broadcasting device from the broadcasting device signal and sends the unique identifier to server 220. At step 3606, server 220 determines that the broadcasting device is associated with an Autogroup by finding the unique identifier of the broadcasting device in Autogroup records 486. At step 3608, server 220 sets a broadcast Autogroup marker in user records 382 for the device that detected the broad casting device's signal. In particular, an Autogroup identifier 487 from Autogroup Records 486 is stored in an Autogroup record 440 as Autogroup ID 441. At step 3610, device 204 instructs the server to accept contact information sent by another device. At step 3612, server 202 looks for Autogroup markers in the user records 382 associated with the sending device and the accepting device. At step 3614, if the same autogroup marker is present for both devices, the server retrieves the dates and times that the autogroup is active from data/time field 493 of the autogroup record 490. At step 3616, if the contact information was sent during an active time for the autogroup, the server creates the group (if not already created) in group's records 430 on the accepting device's user records 382 and adds the contact that is being accepted to the autogroup. In addition, server 220 sends the logo 499 for the autogroup to the device so that the device can display the logo when showing the contact.

The method described above can be used in convention settings where convention operators can obtain and register a broadcasting device and thereby allow the logo of the convention to be shown next to any contacts made during the convention. Similarly, restaurants and bars can register a broadcast device so that their logo can be associated with any contacts made at the restaurant or bar. Such autogroups provide a fast way for user to find contacts since users can often recall the event they were at when they met a person. By simply looking for the autogroups associated with that event, the user is able to quickly narrow down the list of possible contacts they met at an event and thereby discover information for a particular contact.

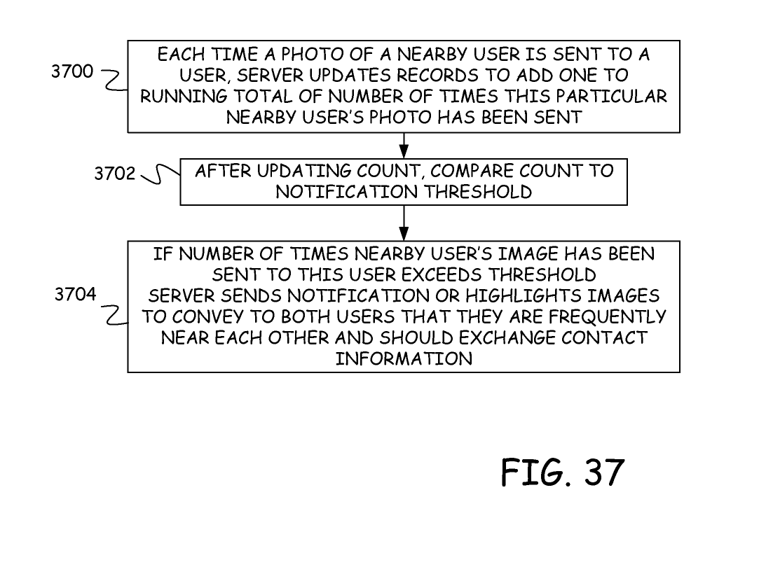

In accordance with a further embodiment, users are automatically notified of potential contacts by server 220 when server 220 recognizes that the users have been near each other more than a threshold number of times. FIG. 37 provides a flow diagram of one method for providing such notifications. At step 3700, each time an image of a nearby user is sent to another user's device, server 220 updates nearby user history records 436 to add one to a running total 438 representing the number of times that a nearby user's image has been sent to a particular user. Each nearby user history record 436 includes the running total 438 and a user ID 437, which is the identifier of the other user. At step 3702, after updating the count, server 220 compares the count to a notification threshold. If the number of times the nearby user's image has been sent to this user exceeds the threshold, server 220 sends a notification or highlights the image to convey to both users that they are frequently near each other and should exchange contact information at step 3704.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
detecting a wireless signal from a mobile device;
determining an identifier for the mobile device from the wireless signal;
transmitting the identifier to a server; and
sending a request to the server to trigger the server to send information to the mobile device, wherein the server uses a different identifier for the mobile device than the identifier determined from the wireless signal in order to route the information to the mobile device.

2. The method of claim 1 wherein the wireless signal comprises a signal with an expected range of less than 200 yards.

3. The method of claim 1 further comprising transmitting an information identifier to the server that identifies the information to be sent to the mobile device.

4. The method of claim 3 wherein the information identifier identifies an entity registered with the server.

5. The method of claim 1 wherein detecting the wireless signal comprises detecting the wireless signal on a second mobile device.

6. The method of claim 5 wherein the information sent by the server comprises contact information associated with a user of the second mobile device.

7. The method of claim 6 wherein the contact information comprises a social media username.

8. The method of claim 5 wherein the information sent by the server comprises product information for ordering a product.

9. A method comprising:
detecting on a computing device that a second computing device is within wireless range of the computing device;
transmitting an instruction from the computing device to a server to send contact information for interactive communications to the second computing device.

10. The method of claim 9 wherein detecting on a computing device that a second computing device is within wireless range of the computing device comprises the computing device detecting a wireless signal generated by the second computing device, and wherein the method further comprises:
the computing device determining an identifier for the second computing device from the wireless signal; and
the computing device sending the identifier to the server.

11. The method of 10 wherein the computing device further sends an identifier of the contact information to send to the second computing device.

12. The method of claim 9 further comprising providing a user interface by:
the computing device receiving an image of a user of the second computing device from the server;
the computing device displaying the image;
the computing device displaying at least one control that allows the user to select the image to cause the instruction to be transmitted from the computing device to the server.

13. The method of claim 12 wherein the at least one control allows the user to designate the contact information that is to be sent to the second computing device.

14. The method of claim 13 wherein the contact information comprises a username on a social media service.

15. The method of claim 13 wherein the at least one control comprises multiple controls with each control designating different contact information to send.

16. The method of claim 9 further comprising receiving on the computing device a request from the server to accept contact information associated with a user of the second device.

17. A method comprising:
displaying a user interface on a device showing images of people in proximity to the device; and
through the user interface, providing the ability to share contact information with the people displayed on the user interface before receiving contact information from the people displayed on the user interface.

18. The method of claim 17 further comprising the user interface not providing the ability to share contact information with people not displayed on the user interface.

19. The method of claim 17 wherein displaying images of people in proximity to the device comprises displaying images pushed by a server to the device.

20. The method of claim 1 wherein providing the ability to share contact information comprises providing the ability to select what contact information to share with each person displayed on the user interface.
